(19) United States
(12) Patent Application Publication
(10) Pub. No.: US 2026/0126797 A1
(43) Pub. Date: May 7, 2026

(54) VEHICLE CONTROL DEVICE, VEHICLE, FEATURE OPTIMIZATION DEVICE, SYSTEM, METHOD AND COMPUTER PROGRAM PRODUCT

(71) Applicant: Astemo, Ltd., Tokyo (JP)

(72) Inventors: Quan NGUYEN, London (GB); Anthony Emeka OHAZULIKE, Valbonne (FR); Alireza AHRABIAN, London (GB); Ioannis SOUFLAS, Valbonne (FR)

(73) Assignee: Astemo, Ltd., Tokyo (JP)

(21) Appl. No.: 19/427,569

(22) Filed: Dec. 19, 2025

Related U.S. Application Data
(63) Continuation of application No. PCT/JP2024/021764, filed on Jun. 14, 2024.
(63) Continuation-in-part of application No. PCT/JP2024/024291, filed on Jul. 4, 2024.

(30) Foreign Application Priority Data
Jun. 21, 2023 (DE) 102023205806.5
Jul. 12, 2023 (DE) 102023206626.2

(51) Int. Cl. G05D 1/243; G01C 21/00; G05D 111/10; G05D 111/30

(52) U.S. Cl. CPC G05D 1/243; G01C 21/3804; G05D 2111/17; G05D 2111/32

(57) ABSTRACT

The present subject matter relates to a control device, a feature optimization device, a system, a vehicle, a method and a computer program product for controlling a movement of a vehicle, in particular for controlling a movement of an autonomous driving vehicle. Based on a current image of the vehicle's environment a map is selected from a plurality of maps stored in a database, a global pose of the vehicle is determined based on a comparison of the current image and the selected map and the movement of the vehicle is controlled based on the determined global pose thereof.

### CROSS-REFERENCE TO RELATED APPLICATION(S)

This application is a continuation of International Application No. PCT/JP2024/021764, filed Jun. 14, 2024, which claims priority to and the benefit of German Patent Application No. 10 2023 205 806.5, filed Jun. 21, 2023, the entire contents of both of which are incorporated herein by reference. This application is also a continuation-in-part of International Application No. PCT/JP2024/024291, filed Jul. 4, 2024, which claims priority to and the benefit of German Patent Application 10 2023 206 626.2, filed Jul. 12, 2023, the entire contents of both of which are incorporated herein by reference.

### TECHNICAL FIELD

The present subject matter relates to a vehicle control device, a feature optimization device, a system, a vehicle, a method and a computer program product for controlling a movement of a vehicle.

The present subject matter relates to a vehicle control device, a vehicle including a vehicle control device, a prediction device, a system, a method, and a computer program product for controlling a first vehicle when a second vehicle is detected in a vicinity of the first vehicle.

### BACKGROUND ART

Vehicle localisation is one of the most important tasks related to automated driving. Although satellite navigation systems can provide a high localisation accuracy, they are limited to applications where there is sufficient satellite signal availability. However, when driving through an urban area with a high density of towering buildings, signals from navigational satellites may be severely affected. To overcome the limitations of satellite navigation systems, information from multiple sensors such as GNSS, LiDAR, camera, accelerometer, and wheel encoder can be fused for creating a full 3D map of a vehicle environment.

In this context, Patent Literature 1 relates to systems and methods for updating an HD map. The system includes a communication interface to receive sensor data acquired of a target region by at least one sensor equipped on a vehicle as the vehicle travels along a trajectory via a network. The system further includes a storage to store the HD map, and a processor that constructs the HD map from a plurality of local HD maps.

In order to increase active safety, current vehicles are equipped with a variety of advanced driver assistance systems (ADAS) warning a driver in critical situations or independently supply vehicle guidance tasks. In particular, road intersections are notorious accident blackspots where many accidents occur when turning onto another road. In order to deal with such critical situations, an intersection assistant can support the driver when entering into an intersection. To further increase safety in this regard, knowledge of future trajectories of vehicles (target vehicles) in the vicinity of one's own vehicle (ego vehicle) is essential.

In this context, Patent Literature 1 describes a predicting apparatus including an acquiring unit that acquires a movement history of another vehicle from the other vehicle; a predicting unit that predicts a behaviour of the other vehicle based on the movement history; and an output unit that outputs driving support information based on the prediction. The acquiring unit acquires the movement history from the other vehicle in a communication range of inter-vehicle communication, and the predicting unit predicts the behaviour of the other vehicle in the communication range of the inter-vehicle communication.

### CITATION LIST

### Patent Literature

Patent Literature 1: US 2020/341150 A1
Patent Literature 1: US 2018/0370530 A1

### SUMMARY OF INVENTION

### Technical Problem

The use of a full 3D map of the vehicle environment, however, has limitations in terms of data efficiency and scalability. To overcome these limitations a solution is proposed which allows accurate and reliable vehicle localisation while reducing computationally intensive operations.

However, performing prediction of the future trajectory of a target vehicle still requires improvement and, for example, intersections still may pose problems for known systems which should be overcome for increasing comfort of a driver of an ego vehicle and safety.

### Solution to Problem

The herein described subject matter addresses the technical object of providing data-efficient and accurate vehicle localisation in regions with limited GNSS availability. This object is achieved by the subject matter of the independent claims. Further preferred developments are described in the dependent claims.

According to the subject matter set forth in the appended claims, there is proposed a vehicle control device, a feature optimization device, a system, a vehicle, a method and a computer program product for controlling a movement of a vehicle, in particular for controlling a movement of an autonomous driving vehicle. It may also be possible that the vehicle is a non-autonomous driving vehicle having a plurality of advanced driver assistance systems (ADAS). Thus, the meaning of “controlling a movement” may also include the meaning that guidance is output to a driver of the vehicle in the form of visual guidance, e.g. on a map displayed in the vehicle, an audio guidance and/or the like.

A least one of the vehicle control device and the feature optimization device may include a processor and a memory for performing all functions of the sub-units thereof described in the following. The feature optimization device may be provided as hardware or software. and may be integrated in the vehicle control device or may be located in a separate computing device. In the latter case, the feature optimization unit may preferably be located on a server, in particular on a cloud server.

The vehicle is equipped with one or more sensors suitable of detecting an environment thereof. The one or more sensors may comprise one or more visual sensors and one or more motion sensors. The one or more visual sensors may be, e.g., a radar sensor, a LiDAR sensor and/or a camera, and the one or more motion sensors may be an inertial measurement unit (IMU), an accelerometer and/or a wheel encoder. Preferably the vehicle may be equipped with a stereo camera, an IMU and a wheel encoder. Furthermore, the vehicle may comprise a receiver for receiving a radio signal from a global navigation satellite system (GNSS receiver). The GNSS receiver may be integrated in the proposed vehicle control device or maybe located remote from the vehicle control device in/on/at the vehicle.

The vehicle control device comprises a localisation unit that determines a global pose of the vehicle and a control unit that then controls the movement of the vehicle based on the determined pose (position and orientation) thereof. The term “global pose of the vehicle” shall preferably be understood as a position and orientation of the vehicle in the world, e.g. in a map frame such as a GNSS reference frame. Such a global pose can be determined directly from the GNSS signal or from a map of the environment providing global coordinates. The latter can be used, for example, in a case where the GNSS signal is deteriorated, e.g., due to high buildings in the environment of a GNSS receiver.

In the case of an autonomous driving vehicle, the control device may control the entire driving operation when it controls the movement of the vehicle, while in the case of a non-autonomous vehicle, the control device may control certain operations of the vehicle, such as parking or changing lanes when it controls the movement of the vehicle.

Further, in case of a non-autonomous vehicle, the control device may control the movement in the sense of providing guidance to the driver, such as displaying driving advice, a map or the like.

The localisation unit of the vehicle control device includes a visual position localisation unit that obtains a current image of an environment of the vehicle from the one or more sensors attached to the vehicle. For example, a camera of the vehicle may capture a current image of the vehicle's environment when the vehicle enters a region where the GNSS signal is degraded.

The visual position localisation unit subsequently sends the current image to a feature optimisation device storing a plurality of sets of optimised features of the environment of the vehicle in a database. The environment of the vehicle may be, for example, surroundings of a road on which the vehicle regularly travels, and the current image may be an image taken at this moment at a particular position of a trajectory of the vehicle on this road. In particular, the plurality of sets of optimised features stored in the database may cover regions with limited GNSS availability. There may be a plurality of sets of optimised features stored in the database covering a plurality of GNSS denied regions, such as regions with limited GNSS availability. Each vehicle driving through a same region, route, environment or the like may take sequences of images and each of these drive-throughs can also be called a “run” in the following.

A plurality of sets of optimised features may have been generated by the feature optimization device from an image sequence of the vehicle's environment. Each set of optimized features may include a plurality of optimised features, each of which may include 3D and 2D points, where 3D points being in the map frame can be associated to 2D points. A single 3D point can be projected onto either a single or multiple 2D planes. The 2D planes can correspond to several images at differing poses in the map frame. Preferably, each optimised feature in the set of optimised features contains at least two primary pieces of information: 1) Global vehicle pose (map/global coordinate frame), (2) Landmarks—which include the following, e.g.: 2D features, associated 3D features, descriptors etc. (3) (optional) if an image is available that can be included. Hereinafter, the set of optimised features may be called a “map”. So, in this application, the term map may not only include a diagrammatic representation but also a set of optimised features of the environment. For different environments, regions or the like, different sets of optimized features may be stored. In particular, keypoints can be used to refer to 2D points, and landmarks can be used to refer to 3D points in the map. Correspondingly, 2D keypoints for any given image may have 3D points as well which may be estimated using stereo/multiple cameras or machine learning. The term “global camera pose” shall be preferably understood as a position and orientation of the camera taking the image in the world.

In response to the current image transmitted to the feature optimization device, the visual position localisation unit receives therefrom one or more optimised feature(s) selected from the plurality of optimised features based on the current image. In other words, the feature optimization device selects suitable or matching optimised feature(s) to be sent to the vehicle control device according to the environment depicted on the current image. Details of the optimised feature selection are explained later in connection with the feature optimization device. Generally, the selection of the best-matching optimised feature(s) from a repository of sets of optimised features, especially optimized features, considerably helps to improve the pose determination.

The visual position localisation unit then determines the global pose of the vehicle based on a comparison of the current image and the received optimised feature(s). For example, the visual position localisation unit may determine a relative pose of the vehicle between the current image and the optimised feature(s) using image registration and may subsequently compute the global pose of the vehicle using the determined relative pose and the global pose of the vehicle (global camera pose) provided by the optimised feature(s). The term “relative pose of the vehicle” shall be understood preferably in this context as a change in position and orientation of the vehicle relative to another position and orientation of the vehicle.

According to an example, the visual position localisation unit may perform the above described comparison by determining one or more features (e.g. visual features) in the current image and the optimised feature(s) and by computing a relative pose between corresponding features. In this context, the at least one feature may be, for example, one or more reference points (keypoints) representing a distinct point, edge or object in the image, which may be detected using well know feature detection methods such as “scale-invariant feature transform (SIFT)”, “speeded up robust features (SURF)” or “features from accelerated segment test (FAST)”. Any other algorithm suitable to determine reference points (keypoints) may also be possible. The relative pose between two correlating reference points (keypoints) in the current image and the optimised feature may then be computed using a tracking algorithm for tracking features or optical flow in different images such as the KLT (Kanade-Lucas-Tomasi) optical flow tracking algorithm. Any other tracking algorithm suitable to determine the relative pose between the corresponding reference points (keypoints) may also be possible.

Subsequently, the visual position localisation unit determines the global pose of the vehicle by combining the computed relative pose with the global camera pose derived from the optimised feature. As mentioned above, the global camera pose may be a further visual feature included in the optimised feature that may be optimized to be nearly identical to the global pose of the vehicle when capturing the image for optimising the visual features.

By determining the global pose of the vehicle as described above, the visual position localisation unit provides an efficient and reliable procedure for navigating a vehicle through a region with limited GNSS availability.

However, to further reduce the computing power required for vehicle localisation, GNSS can be used for localisation if it is reliably available. According to an example, the localisation unit of the vehicle control device may therefore further include a GNSS receiver. The GNSS receiver does not necessarily have to be positioned inside the localisation unit but may also positioned outside the vehicle control device at another location on/in the vehicle.

If a signal strength of a GNSS signal received by the GNSS receiver is equal to or greater than a predetermined threshold, the localisation unit determines the global pose of the vehicle based on the GNSS signal, and if the signal strength of the GNSS signal is lower than the predetermined threshold, the visual position localisation unit determines the global pose of the vehicle as described above. The predetermined threshold may be set, e.g., according to the accuracy of the global pose that can be achieved with the received GNSS signal. For example, the predetermined threshold may be set to a value below which the GNSS signal is only accurate to e.g. 50 cm or 1 m. Preferably, a deterioration of the GNSS signal may be determined in advance, e.g., by estimating whether a line of sight between a GNSS satellite and the vehicle is blocked.

According to an example, the vehicle control device may further comprise an image processing unit that may obtain an image sequence from the one or more sensors including a predetermined number of images of the environment of the vehicle when the latter passes through a region where the received GNSS signal is lower than the predetermined threshold. In particular, the image processing unit may obtain an image sequence each time the vehicle passes through the region (a run). This allows for sensing the environment from different perspectives as the trajectories along which the vehicle passed the region may change.

Having obtained the image sequence, the image processing unit may send it to the feature optimization device. This means that the image processing may regularly provide an image sequence to the feature optimization device for generating a map of a region having poor GNSS availability. The image sequence may include a predetermined number of images captured spaced apart from each other. The predetermined number of images in each sequence as well as the distance therebetween may be determined according to the environment being captured. For example, an image may be taken each time a significant change is detected in the vehicle's environment. It may also be possible to have equidistant intervals between the images of the image sequence.

In particular, a first image and a last image of the image sequence may include a global pose of the vehicle determined based on the GNSS signal. In this context, a deterioration of the GNSS signal may be estimated in advance, to ensure a GNSS availability when capturing the first image. The presence of information about a global pose in a first and last image of the image sequence improves the accuracy of the set of optimized features to be generated by the feature optimization device from the image sequence.

The proposed feature optimization device comprises an input unit that receives one (or has received from previous drive through events/runs) two or more image sequences of an environment of the vehicle from a vehicle control device. The image sequences can be acquired along different trajectories in the same environment, in particular in a region with limited GNSS availability, by the image processing unit of the control unit as described above. Having received the at least two or more image sequences, the input unit of the feature optimization device determines one or more (visual) features from each image of the at least two image sequences. Preferably, one (actual) image sequence is received from a vehicle which actually drives through an area/environment to be analysed/mapped and the other one or more image sequences are loaded/provided from a storage in which the image sequences of previous recordings.

The features determined by the input unit may be, e.g., the images of the received image sequences, one or more reference points (keypoints) indicating distinct points, edges or objects in the images of the image sequences, an estimated camera pose of each image in the image sequences and one or more landmarks derived by transforming the reference points (keypoints) from a 2D image frame in the map frame using the estimated camera pose. In this context, “an estimated camera pose” of an image shall be understood as a camera pose/vehicle pose determined based on odometry data received from the one or more sensors of the vehicle. For example, an estimated pose of the camera/vehicle may be determined by integrating relative pose measurements obtained using visual odometry and/or IMU and wheel odometry.

The feature optimization device or simply optimization device further includes an optimization unit for optimizing at least one of the one or more features determined by the input device, in order to derive one or more sets of optimized features from the received image sequences. For this purpose, the optimization unit computes, based on the determined features, a first constraint between two successive images of the at least two image sequences and a second constraint between an image of a first image sequence and an image of a second image sequence and jointly optimizes the at least one of the determined features of each image of the at least two image sequences based on the first and second constraints. This means that the optimization unit not only considers constraints between two images consecutively captured when the vehicle travels along a trajectory, but also images taken from two different trajectories captured in the same environment. The first constraints may be applied from the first to the last image of each image sequence and the second constraints may be applied between selected images of the first and second image sequence. For example, each image of the first image sequence may have a constraint to an image of the second image sequence being closest to that of the first image sequence. It may also be possible that a single image of an image sequence has several constraints to different images of the second image sequence. In this way, the optimization of the at least one visual feature of each image is performed over a large number of images and intervening constraints, thereby increasing the accuracy of the optimization.

In particular, the optimization unit may minimize an error of the computed constraints for determining a global camera pose of each acquired image included in the at least two image sequences obtained along the at least two trajectories. After the optimization, the feature optimization device may store each of the image sequences with the optimized features as a set of optimized features (map) in a database. Thus, a map for each trajectory on which the at least two image sequences have been obtained are provided in the database, both including a predetermined number of images or optimised features with which a current image or features thereof can be compared for visual localisation, e.g., when the GNSS signal falls below the predetermined threshold.

The database may be a single database in which all maps are stored, or a plurality of databases, e.g., one database for each map or at least for each set of maps covering a particular region. It may be also possible that the obtained image sequences are stored in the database(s) for later use. The databases may be provided as hardware or software and may be located within the optimization device or remotely therefrom. In the latter, the databases may be located on a server, in particular on a cloud server.

The feature optimization device further has a selection unit that receives a current image of the vehicle's environment from the vehicle control device and selects a set of optimized features from the at least two sets of optimized features stored in the database based on the current image. The current image may be sent from the vehicle control device of the vehicle, for example, when the latter has lost the GNSS signal and may require a map for localisation. This means that the feature optimization device may select the set of optimized features or one or more single optimized features to be sent to the vehicle control device according to the currently captured environment of the vehicle depicted on the current image.

When the selection unit has selected the on or more optimized features, it transmits the selected optimized features to the vehicle control device for determining a global pose of the vehicle therefrom. This allows a fast and accurate localisation of the vehicle, e.g, in regions where no GNSS signal is available. However, providing one or more optimized features to the vehicle control device may not be restricted to situations in which the GNSS signal is weak but may also be possible when the GNSS signal is available, for example, to compare a vehicle pose derived from a selected optimised feature with the pose derived from the GNSS signal to assess the accuracy of the set of optimised features.

According to an example, the selection unit may determine one or more features from the received current image and may select one or more optimised feature by comparing the determined visual features of the current image with the optimized features of the at least two sets stored in the database. For example, the selection unit may determine one or more keypoints in the current image and may compare the determined keypoints with corresponding keypoints in the images of the at least to sets of optimised features stored in the database. This allows for a targeted and simple search including an image matching the environment depicted in the current image.

According to an example, the selection unit may use a probabilistic model and/or an AI model to select a one or more optimised features from the at least two sets of optimised features stored in the database. For example, the k-Nearest-Neighbour Algorithm (KNN) may be used as a probabilistic model and a neuronal network may be used as an AI model. The neuronal network may be trained with a plurality of training sets of optimised features which may be additionally stored in the database. Any other probabilistic and/or AI model suitable for selecting the one or more optimised feature according to the current image may also be possible. The use of a particular model/algorithm for supporting the selection allows to increase the speed thereof and further improves the computational efficiency.

According to an example, the input unit may determine one or more reference points (keypoints) as the one or more features in each image of the received images sequences. The one or more reference points (keypoints) may be determined by the input unit using a feature detection method such as “scale-invariant feature transform (SIFT)”, “speeded up robust features (SURF)” or “features from accelerated segment test (FAST). Any other algorithm suitable to determine the reference points (keypoints) may also be possible. The optimization unit may compute the first constraint by determining a first relative pose between two corresponding reference points in the successive images of the at least two image sequences and may compute the second constraint by determining a second relative pose between two corresponding reference points in the image of the first image sequence and the image of the second image sequence. The relative pose between two correlating reference points (keypoints) in the respective images may be computed using a tracking algorithm such as the KLT (Kanade-Lucas-Tomasi) optical flow tracking algorithm. Any other tracking algorithm suitable to determine the relative pose between the corresponding reference points (keypoints) may also be possible.

In other words, the first constraint may be a relative pose between two successive images of the image sequences and the second constraint may be a relative pose between an image of a first image sequence and an image of a second image sequence, both relative poses determined based on keypoints identified in each image of the image sequences. In terms of the first constraints, it may also be possible to additionally use odometry data received form the motion sensors of the vehicle to determine the relative pose between two successive images.

According to an example, the input unit may determine an estimated camera pose as the at least one visual feature to be optimized in each image of the at least two image sequences. The estimated camera pose may be determined by the input unit using odometry data received from the one or more sensors of the vehicle. The optimization unit may then optimize the estimated camera pose based on the first and second constraints, to generate a global camera pose for each image of the at least two maps. In particular, the optimization unit may minimize an error function including the estimated camera poses and the relative poses therebetween to compute the absolute camera pose. A detailed description of the respective error function is given below in connection with FIG. 2.

It may also be possible that the input unit may determine one or more landmarks as an alternative or additional visual feature to be optimized in each image of the at least two image sequences. The optimization unit may then optimize the one or more landmarks and/or the estimated camera pose based on the first and second constraints, to generate a global camera pose for each image of the at least two maps.

According to an example, the input unit may have determined a global pose of the vehicle in a first and a last image of the at least two image sequences determined based on a GNSS signal received by the one or more sensors. The optimization unit may optimize the estimated camera pose of each image of the at least two image sequences based on the first and second constraints and the global camera pose in the first and last image. This means that the optimization unit may solve the error function by considering the global poses of the first and last images as an additional constraint for further improving the accuracy of the optimization.

According to an example, the input unit may determine one or more visual features from each image of the received new image sequence if the input unit receives a new image sequence from the vehicle control device. The optimization unit may compute, based on the determined visual features, a first constraint between two successive images of the new image sequence and a second constraint between an image of the new image sequence and an image of the at least two maps already stored in the database. The optimization unit may then optimize at least one of the determined visual features of each image of the new image sequence based on the first and second constraints and may store the new image sequence with the optimized visual features as a new map in the database. In other words, the visual features of a new image sequence supplementing the existing maps of the environment may be optimized using the second constraints to each map already stored in the database. A new image sequence may be received by the input unit, every time the vehicle passes through a region where the received GNSS signal is lower than a predetermined threshold. The predetermined threshold may be set, e.g., according to the accuracy of the global pose that can be achieved with the received GNSS signal. This allows for providing a large amount of maps in regions with limited GNSS availability to be selected from for localisation of the vehicle according to a current image.

According to an example, the optimization unit may further optimize the visual features of the at least two maps already stored in the database based on the second constraint between the image of the new image sequence and the image of the at least two maps. This means, that the visual features of each map in the database may also be further optimized using the second constraints to the new map. This allows for continuously improving the accuracy of each map in the database.

The proposed system for controlling a movement of a vehicle comprises a vehicle control device and a feature optimization device as described above as well as one or more sensors attached to the vehicle, which transmit sensor signals to the vehicle control device. The one or more sensors may comprise one or more visual sensors such as a radar sensor, a LiDAR sensor and/or a camera, and one or more motion sensors such as an inertial measurement unit, an accelerometer and/or a wheel encoder.

Furthermore, each configuration of the disclosed vehicle control device, the feature optimization device or the system described above shall also be encompassed by way of a method, which may be claimed by itself and/or by way of a computer program product claim.

The herein described subject matter addresses the technical object of improving the prediction of a future trajectory of a target vehicle, preferably without requiring a direct communication connection between the vehicles. This object is achieved by the subject matter of the independent claims. Further preferred developments are described in the dependent claims.

According to the subject matter set forth in the appended claims, there is proposed a vehicle control device, a vehicle including a vehicle control device, a prediction device, a system, a method, and a computer program product for controlling a first vehicle (ego vehicle) when a second vehicle (target vehicle) is detected at a location of a predetermined road infrastructure in a vicinity of the first vehicle.

The predetermined road infrastructure may comprise, for example, all or specifically selected roads in a city and/or a predetermined region, and a location of the predetermined road infrastructure may be, e.g., an intersection or a section of a (multilane) road.

In particular, the subject matter disclosed herein improves the riding comfort and safety of occupants of the first vehicle when a second vehicle is present in its surroundings by taking into account the behaviour of the second vehicle when controlling the first vehicle. It may be also possible that more than one second vehicle is detected in the vicinity of the first vehicle, the behaviour of which may be considered when controlling the first vehicle. Vicinity/Surroundings or the like may be definable as close space around the ego vehicle, wherein close space may be relatively defined depending on speed of the ego vehicle, certain areas of interest, etc. If defined by absolute values, the vicinity may be defined by a radius of a predetermined number of meters around the ego vehicle, wherein the radius may have a size of 10 m, 20 m, 50 m, 100 m, 200 m, or the like.

The vehicle control device of the first vehicle comprises a state estimation unit estimating a state of the second vehicle using one or more signals of a plurality of sensors attached to the first vehicle. The plurality of sensors may include, e.g., at least one camera, at least one radar sensor, at least one lidar sensor, at least one ultrasonic sensor, at least one inertial measurement unit (IMU) and/or any other sensor suitable to detect a second vehicle at a location in the vicinity of the first vehicle and to provide measuring signals for estimating the state of the second vehicle. The plurality of sensors may be electrically connected to the vehicle control unit for providing the required sensor signals to detect the second vehicle and to estimate its state.

Alternatively or additionally the state estimation unit may receive the estimated state of the second vehicle from an external unit (external/remote state estimation unit), such as a road side unit with which the ego vehicle communicates and/or an external, remote computer (server) with which the ego vehicle may communicate and receive the estimated state. In other words, the state estimation unit may have a reduced configuration in which it principally includes communication unit(s) for communicating with the external unit which provides the estimated state, the state estimation unit may include the communication unit(s) and the above explained sensors etc. even though it may only use the one or the other for receiving information about the estimated state of the second vehicle, or the state estimation unit may include the communication unit(s) and the above explained sensors and it uses both to receive/estimate the estimated state of the second vehicle. In the latter option, the state estimation unit may, e.g., fuse the received information about the estimated state from the external server with the estimated state of the second vehicle derived from the own sensor data to improve the accuracy thereof. The external unit may estimate the state of the second vehicle, e.g., based on information from road side sensors or from related information transmitted from the second vehicle or even other vehicles.

Furthermore, the vehicle control device has a vehicle interface unit sending automatically a request for predicting an expected/future trajectory of the second vehicle together with the estimated state of the second vehicle to a prediction device and receiving a predicted expected trajectory from the prediction device. In other words, if a second vehicle is detected at a location in a vicinity of the first vehicle by at least one of the plurality of sensors attached thereto, the state of the vehicle is estimated by the state estimation unit of the vehicle control device based on the received sensor signals (or the data/information received from an external unit) and a request for predicting an expected trajectory of the second vehicle is sent to the prediction device by the vehicle interface unit of the vehicle control device. The request is flanked by the estimated state of the second vehicle, which is then taken into account by the prediction device when calculating the expected trajectory along with information about a behaviour of a plurality of vehicles at the location of the second vehicle.

The location of the second vehicle may be understood as a location of the predetermined road infrastructure where the second vehicle may be detected in the vicinity of the first vehicle. There may be a plurality of locations of the second vehicle, which may be distributed over the predetermined road infrastructure and may include, for example, a plurality of intersections and/or road sections.

The state of the second vehicle estimated by the state estimation unit of the vehicle control device of the first vehicle or by a remote computer may, for example, include size of the vehicle, pose of the vehicle, class of vehicle, position, heading, velocity and/or acceleration/deceleration of the second vehicle. Considering these parameters when calculating the expected trajectory allows for predicting the latter with high accuracy.

For example, if the first vehicle approaches an intersection (as a location of the predetermined infrastructure) where a second vehicle is ahead of the first vehicle (in its vicinity), the vehicle control device of the first vehicle estimates or receives the state of the second vehicle when detecting the latter, such as its position, heading/direction, velocity and deceleration, or the like, if any, and sends a request for a prediction of an expected trajectory of the second vehicle to the prediction device. At an intersection an expected trajectory may be, for example, a left turn, a right turn, or a head-on trajectory. A further example for a location where a second vehicle may be detected in the vicinity of the first vehicle (location of the second vehicle) may be a section of a multilane road, e.g. an expressway or highway, on which one or more second vehicles may travel alongside the first vehicle. In this case, an expected trajectory of a second vehicle may be, for example, a lane change.

By knowing the state of the second vehicle when predicting its expected trajectory, the probability of a possible trajectory can be narrowed down and predicted more accurately. Furthermore, the above configuration and its modifications also offer the possibility to predict trajectories of a plurality of (second) vehicles driving through the road infrastructure.

Moreover, the vehicle control device includes a vehicle control unit controlling a state of the first vehicle based on the predicted expected trajectory received from the prediction device and/or displaying the predicted expected trajectory received from the prediction device to a driver of the first vehicle. The state of the first vehicle may, for example, also include position, heading, velocity and/or acceleration/deceleration thereof. This means that a behaviour of the first vehicle is controlled in response to the expected trajectory of the second vehicle predicted on demand by the prediction device. The knowledge of an expected trajectory of the second vehicle allows to control the state of the first vehicle in foresight and thus to avoid, for example, a need for heavy braking or even a collision.

According to an example, the vehicle control device may further comprise an environment estimation/information unit configured to estimate information about an environment of the second vehicle (environment information) using one or more signals of the plurality of sensors attached to the first vehicle. For example, the information about the environment of the second vehicle may comprise information about traffic and road infrastructure in the environment of the second vehicle, such as traffic in lanes next to the second vehicle and/or traffic signs regulating the operation of the second vehicle. These information may be determined by using, for example, the at least one camera which may capture one or more pictures of the surroundings of the second vehicle to collect information about its environment. Furthermore, the environment information may include map information about the location of the second vehicle such as a lane map comprising, e.g., a three dimensional map with precise positions of some important features of a road, like lane marks and traffic signs. In this way, the current options of the second vehicle to select a particular direction/route/trajectory can be monitored/estimated by the environment estimation unit of the vehicle control device. Alternatively or additionally, the environment estimation unit may be located remote to the ego vehicle so that a remote computer may perform the environment estimation and/or instead of sensors of the ego vehicle data/signals/information from external units (summarized us external/remote environment information unit(s)) may be used for the environment estimation, such as map information from an external map provider/computer, such as signals from road side units, or the like.

According to an example, the vehicle interface unit of the vehicle control device may send the estimated information about the environment of the second vehicle to the prediction device when sending the request for predicting the expected trajectory of the second vehicle. This means that the environment information can also be used by the prediction device to narrow down the possible route options of the second vehicle and to predict the expected trajectory with high accuracy. Furthermore, the fact that the prediction device receives environment information of the second vehicle from the first vehicle monitoring the latter, enables an arbitrary position of the prediction device and offers the possibility to predict trajectories of a plurality of vehicles driving through a road infrastructure.

According to an example, the vehicle interface unit of the vehicle control device may be configured to show an information about the received predicted expected trajectory of the second vehicle on a display. The display may be, for example, a part of the vehicle interface unit and may be mounted inside the vehicle in the driver's field of sight. The information about the received predicted expected trajectory of the second vehicle may include besides the trajectory itself, for example, a predicted probability of the expected trajectory, a recommended speed for the first vehicle and an action notice to the driver. In case of an autonomous driving vehicle, the recommended speed for the first vehicle and the notice to the driver may merely serve to inform the driver of the manner in which the vehicle is controlled, with the driver having the option to override the automatic vehicle control. In case of non-autonomous driving, the recommended speed for the first vehicle and the notice to the driver may be a request to the driver to navigate the first vehicle depending on the predicted expected trajectory of the second vehicle.

Furthermore, it is provided a vehicle comprising a vehicle control device as described above and a plurality of sensors attached to the vehicle and connected to the vehicle control device. The vehicle may be an autonomous driving vehicle, or a vehicle driven by a driver having one or more advanced driving assistance systems (ADAS), such as a braking assistant, an intersection assistant and/or a lane change assistant. In particular, the plurality of sensors may include, e.g., at least one camera, at least one radar sensor, at least one lidar sensor, at least one ultrasonic sensor, at least one inertial measurement unit (IMU) and/or any other sensor suitable to detect one or more other vehicles in the vicinity of the vehicle and to provide measuring signals for estimating a state of the one or more other vehicles. In particular, a combination of the plurality of sensors may be used to estimate the state of the one or more other vehicles, such as their position, heading, velocity and/or acceleration/deceleration, with high accuracy.

A prediction device for predicting an expected trajectory of a second vehicle (target vehicle) detected at a location of a predetermined infrastructure in a vicinity of a first vehicle (ego vehicle) comprises a prediction interface unit that receives a request for predicting an expected trajectory of the second vehicle together with an estimated state of the second vehicle from a vehicle control device of the first vehicle. Furthermore, the prediction interface unit of the prediction device sends a predicted expected trajectory of the second vehicle back to the vehicle control device of the first vehicle.

The prediction device may be a separate sever/computer/service cloud located at an arbitrary position. It may be located close to the predetermined road infrastructure or it may be located completely remote in a server center or the like. In this case the prediction device may be connected to the vehicle control device via a network such as a wireless local area network, a cellular network and/or any other network suitable for exchanging data between the prediction device and the vehicle control unit. Alternatively the prediction device may be included in the vehicle control device of the first vehicle. The estimated state of the second vehicle received by the prediction interface unit of the prediction device may include position, heading, velocity and/or acceleration/deceleration of the second vehicle. By providing the state of the second vehicle to the prediction device, the latter may be enabled to narrow down the possible route options/trajectories of the second vehicle and to predict the expected trajectory with high accuracy. It may further be an option that the prediction device and, if provided outside of the ego vehicle, the state estimation unit are provided on the same server/remote computer or on different ones.

The prediction device further comprises a model unit predicting the expected trajectory of the second vehicle using a prediction model considering information about previous behaviour of a plurality of vehicles at the location of the second vehicle, and the received estimated state of the second vehicle. The location of the second vehicle may be, e.g., an intersection or a lane of a (multilane) road in the predetermined road infrastructure. There may be a plurality of locations of the second vehicle in the predetermined road infrastructure, being, e.g., intersections or lanes of a (multilane) road. In particular, the location of the second vehicle may be at least one intersection, and the prediction unit may gather information about a behaviour of a plurality of vehicles at the at least one intersection by monitoring a predetermined number of vehicles traversing the latter. The behaviour information of each monitored vehicle may be stored as a dataset in a storage of the prediction device. The prediction model of the model unit, which may preferably be a statistical model, can then predict the expected trajectory based on the gathered information about the behaviour of the monitored vehicles crossing the intersection.

For example, the predetermined number of monitored vehicles at the location of the second vehicle may be a number sufficient to determine a probability distribution regarding the behaviour of the monitored vehicles. In particular, the behaviour of the plurality of vehicles passing the location of the second vehicle may be continuously monitored, and when a number of behaviour information datasets exceeds the predetermined number by one, the first dataset stored in the storage of the prediction device may be deleted and the last monitored behaviour may be stored as new dataset in the storage. In this manner, the stored datasets can be kept up to date.

According to an example, the prediction interface unit of the prediction device can be connected to one or more road side units positioned at the location of the second vehicle capturing a trajectory and a state of each of a plurality of vehicles thereat, which may be stored together as a dataset in the storage of the prediction device.

In this case, the model unit of the prediction device may determine information about the behaviour of the plurality of vehicles at the location of the second vehicle based on the trajectory and the state of each of the plurality of vehicles captured by the one or more road side units. In particular, the state of each vehicle may be assigned to its trajectory when storing it, so that a behaviour of a respective vehicle can also be determined in view of its state. For example, if a vehicle enters an intersection at a velocity that is above a certain value, it may be observed more frequently that the respective vehicle does not turn left or right but drives straight ahead.

The one or more road side units may be positioned, e.g. at each intersection of the predetermined road infrastructure and/or alongside one or more roads thereof. Each of the one or more road side units may include at least one sensor such as a camera, a radar sensor, a lidar sensor or an ultrasonic sensor or any other sensor suitable to capture a trajectory, a state and information about an environment of each of the plurality of vehicles. Furthermore, it may be possible that the prediction device is also included in one of the one or more road side units.

According to an example, the model unit of the prediction device may determine a probability distribution of the captured trajectories at the location of the second vehicle as an information about the behaviour of the plurality of vehicles thereat. To calculate the probability distribution, the model unit may count the number of vehicles that select a particular trajectory at the location of the second vehicle and relate the respective counted number to the total number of vehicles passing the location of the second vehicle. In this regard, the model unit may consider the state of the plurality of vehicles at the location of the second vehicle when determining the probability distribution. For example, several probability distribution of the captured trajectories may be determined depending on a velocity, a heading and/or an acceleration/deceleration of each vehicle entering/traversing the location of the second vehicle.

According to an example, the prediction model may be an AI model, and the model unit may use the determined information about the behaviour of the plurality of vehicles at the location of the second vehicle as training data for training the prediction model. The prediction model trained in this way may then predict the expected trajectory at the location of the second vehicle. The AI model may be, for example, a neural network model which may be trained with the stored datasets including trajectories and states of the plurality of vehicles captured by the one or more road side units and/or by the first vehicle at the location of the second vehicle.

According to an example, the model unit of the prediction model may comprise a training unit that may receive the training data and may label the received training data according to the state of each of the plurality of vehicles at the location of the second vehicle. In particular, the training unit may label the captured trajectories included in the training data with the states of the corresponding vehicles. In this way, the training unit may provide pre-sorted training data for training the prediction model which can improve the accuracy and capabilities of the trained AI model.

According to an example, the prediction interface unit of the prediction device may additionally receive information about an environment of the second vehicle, and the model unit of the prediction device may determine all potential trajectories of the second vehicle based on the received environment information for predicting the expected trajectory. For example, the information about the environment of the second vehicle (environment information) may comprise information about traffic and road infrastructure in the environment of the second vehicle, such as traffic in lanes next to the second vehicle and/or traffic signs regulating the operation of the second vehicle. Furthermore, the environment information may include map information about the location of the second vehicle such as a lane map comprising, e.g., a three dimensional map with precise positions of some important features of a road, like lane marks and traffic signs. Such information can be used to determine whether the second vehicle has any chance at all, of turning off in one direction or the other or changing lanes. If, for example, there is very heavy traffic in an adjacent lane, it can be assumed that the second vehicle does not have the possibility to turn into this lane. In other words, the information about the environment of the second vehicle can be used by the model unit to determine all possible options of the second vehicle to select a particular direction/route/trajectory (potential trajectories) and to exclude impossible options. In this way, the efficiency of the prediction model can be increased since trajectories that are deemed impossible by the model unit in advance may not be considered therein at all.

According to an example, the model unit of the prediction device may predict the expected trajectory by determining a probability for each potential trajectory of the second vehicle and choosing the potential trajectory having the highest probability. In particular, the probability of each potential trajectory of the second vehicle may be determined by the prediction model of the model unit based on the determined probability distributions of the captured trajectories at the location of the second vehicle considering the received state thereof. This means that the model unit may compare, for example, a velocity and a heading of the second vehicle describing its current state with a velocity and a heading assigned to the different probability distributions determined in advance. As an example, the model unit may then select a probability distribution labelled with the same or at least a similar velocity and heading for determining the probability for each potential trajectory of the second vehicle. Finally, the model unit may choose the trajectory having the highest probability as the expected trajectory. In case that the prediction model is an AI model trained with the determined probability distributions of the captured trajectories at the location of the second vehicle, the AI model may automatically choose the probabilities of each potential trajectory of the second vehicle according to the received state thereof.

According to an example, the prediction interface unit of the prediction device may receive the state of the second vehicle from at least one of the one or more road side units. This means that the prediction interface unit may receive the state of the second vehicle not only from the vehicle control unit of the first vehicle but also from at least one of the road side units at the location of the second vehicle. This allows for improving the accuracy of the state estimation, as each parameter thereof (e.g. position, velocity, acceleration) is determined from a different perspective by different sensors. Moreover, if the state of the second vehicle is determined by more than one road side unit at different locations of the second vehicle, information about a course of a route of the second vehicle may also be included in the estimated state provided by the respective road side units.

According to an example, the prediction interface unit may receive the additional information about the environment of the second vehicle (environment information) from the vehicle control device of the first vehicle and/or from at least one of the one or more road side units. If the prediction interface unit receives the environment information from the vehicle control device of the first vehicle, a plurality of sensors attached to the first vehicle may be used to determine said information. The plurality of sensors may comprise, e.g., at least one camera, at least one radar sensor, at least one lidar sensor, at least one ultrasonic sensor, at least one inertial measurement unit (IMU) and/or any other sensor suitable to determine an environment of a second vehicle in the vicinity of the first vehicle. For example, the at least one camera may capture one more pictures of the surroundings of the second vehicle to collect, e.g., information about traffic in one or more lanes next to a lane in which the second vehicle is present.

If the prediction interface unit additionally receives environment information of the second vehicle from one or more road side units, such information may include the same or different information than the environment information received from the control device of the first vehicle. The first vehicle may be positioned, e.g., behind the second vehicle, while the one or more road side units may be positioned next to and/or in front of the second vehicle. Based on the different positions of the first vehicle and the road-side unit(s), e.g., a camera of the first vehicle and a camera of a road-side unit may capture images from different directions and thus provide different environment information of the second vehicle. In view of this, it is preferable to receive environmental information from both the control device of the first vehicle and the one or more road side units to ensure that all of the current options of the second vehicle for selecting a particular direction/route/trajectory are determined, and to predict the expected trajectory of the second vehicle with high accuracy.

A system for controlling a first vehicle when a second vehicle is detected at a location of a predetermined road infrastructure in a vicinity of the first vehicle comprising a vehicle control device and a prediction device as described above, and a plurality of road side units positioned at a plurality of different locations in the predetermined road infrastructure. Each of the plurality of different locations may be a location of the second vehicle meaning that the second vehicle may be detected at these locations in the vicinity of the first vehicle. The plurality of road side units may be positioned, for example, at a plurality of intersections and/or road sections of the predetermined road infrastructure. The prediction device may be a separate sever/computer/service cloud located at an arbitrary position. In this case the prediction device may be connected to the vehicle control device via a network such as a wireless local area network, a cellular network and/or any other network suitable for exchanging data between the prediction device and the vehicle control unit. Alternatively, the prediction device may be included in the vehicle control device of the first vehicle.

According to an example, the one or more road side units the plurality of road side units form a road side unit network configured to exchange information between different road side units. This allows, for example, to send a first state of the second vehicle determined by a first road side unit positioned at a first location in the predetermined road infrastructure to a second road side unit determining a second state of the second vehicle at a second location in the predetermined road infrastructure. Each of the first and second states of the second vehicle may include, for example, a position, a heading, a velocity, and/or an acceleration/deceleration of the second vehicle at the first and second locations, respectively. In this manner, the second road side unit may determine, for example, a course of a route of the second vehicle through the predetermined road infrastructure.

Furthermore, each configuration of the disclosed vehicle control device, the prediction device or the system described above shall also be encompassed by way of a method, which may be claimed by itself and/or by way of a computer program product claim.

### Advantageous Effects of Invention

Summarizing, the present invention enables an accurate and reliable vehicle localisation in regions with limited GNSS availability by providing a plurality of maps for these regions and selecting an appropriate map therefrom to locate a vehicle at a particular position.

Summarizing, a vehicle control device, a prediction device, a system, a method and a computer program product for controlling a first vehicle (ego vehicle) when a second vehicle (target vehicle) is detected in its vicinity can be provided which in particular increase the safety of occupants of the first vehicle by taking into account an expected behaviour of the second vehicle when controlling the first vehicle. The expected behaviour of the second vehicle is predicted based on information about the previous behaviour of a plurality of vehicles monitored at a location of the second vehicle taking into account a state of each of the plurality of monitored vehicles, which may be, e.g., vehicle type, position, heading, velocity and/or acceleration/deceleration of the respective vehicle. The information about the vehicle type or class etc. may be used, if available, as additional “state” information.

### BRIEF DESCRIPTION OF DRAWINGS

FIG. 1 shows schematically and exemplarily a system for controlling a movement of a vehicle according to an embodiment of the present invention.

FIG. 2 shows schematically and exemplarily an optimization of a two image sequence which may be performed by the optimization unit of the system shown in FIG. 1.

FIG. 3 shows a flow chart describing exemplary steps for generating a plurality of optimized features using the optimization shown in FIG. 2.

FIG. 4 shows a flow chart describing exemplary steps for determining a global pose of a vehicle according to another embodiment of the present invention.

FIG. 5 shows schematically a determination of a global pose of the vehicle according to step S404 of the flow chart shown in FIG. 4.

FIG. 6 shows schematically an exemplary situation at a location of a predetermined road infra-structure in which the present invention can be utilized.

FIG. 7 shows schematically and exemplarily a system according to an embodiment of the present invention that includes a vehicle control device, a prediction device and a plurality of road side units.

FIG. 8 shows schematically and exemplarily a training unit of the prediction device depicted in FIG. 7.

FIG. 9 shows schematically an example as to how training data is generated by the training unit depicted in FIG. 8.

FIG. 10 shows schematically and exemplarily a result of the training data generation depicted in FIG. 9.

FIGS. 11a and 11b show schematically another exemplary situation at the location of the predetermined road infrastructure shown in FIG. 6 in which the present invention can be utilized.

FIGS. 12a and 12b show schematically yet another exemplary situation at the location of the predetermined road infrastructure shown in FIG. 1 in which the present invention can be utilized.

FIGS. 13a and 13b show schematically one more exemplary situation at another location of the predetermined road infrastructure in which the present invention can be utilized.

### DESCRIPTION OF EMBODIMENTS

### <First Aspect of Invention>

In the following, embodiments of the present invention are described in detail with reference to exemplary figures. The features of the embodiments may be combined in whole or in part, and the present invention is not limited to the embodiments described. In the figures, identical elements are provided with identical reference signs, so that a repeated description of the elements is omitted unless necessary.

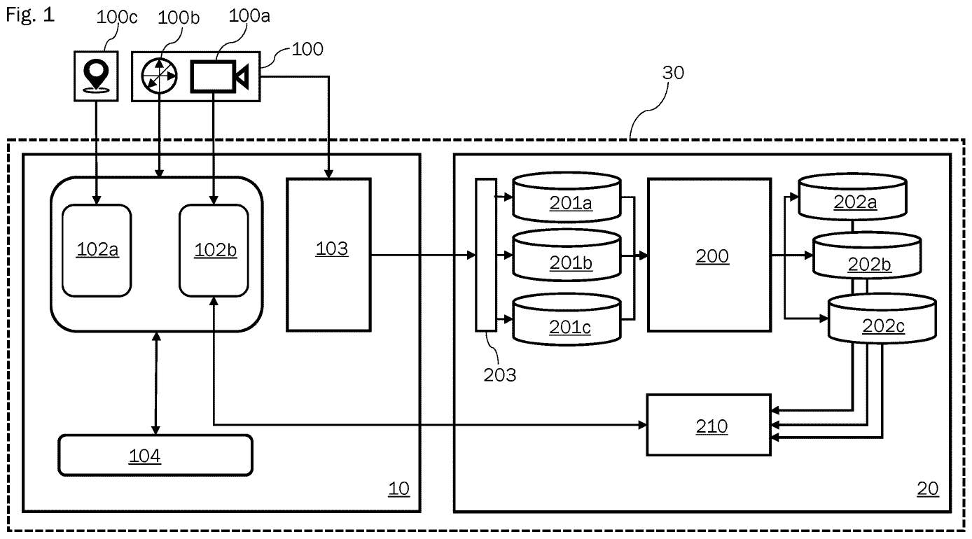

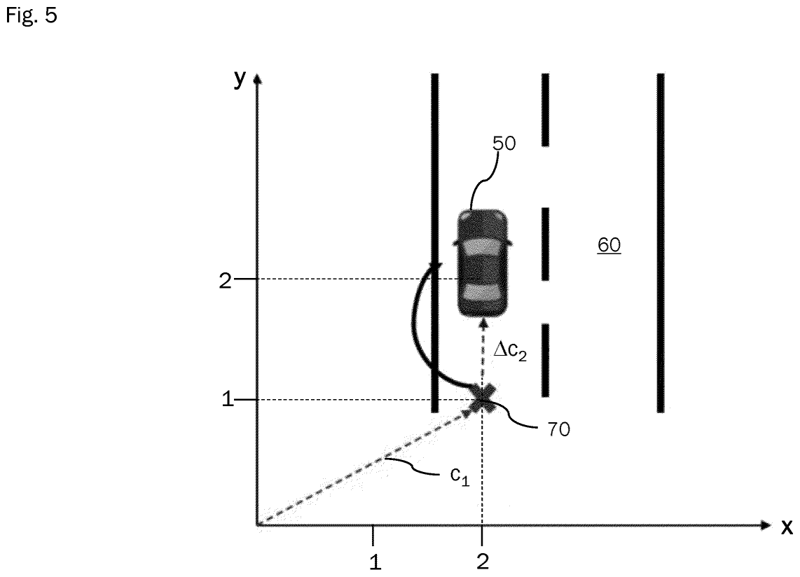

FIG. 1 shows schematically and exemplarily a system 30 for controlling a movement of a vehicle 50 (see FIG. 5) according to an embodiment of the present invention. The depicted system 30 includes a vehicle control device 10, a sensor unit (one or more sensors) 100 and a feature optimization device 20.

The sensor unit 100 shown comprises a camera 100a, which may preferably be a stereo or an RGB-D camera, and an inertial measurement unit (IMU) 100b, which may preferably be a 6D IMU having three accelerometers and three gyroscopes, or a 9D IMU having additionally three magnetometers. The sensor unit 100 is attached to the vehicle 50 and connected to the vehicle control device 10.

The depicted vehicle control device 10 comprises a localisation unit 102, an image processing unit 103 and a control unit 104.

The localisation unit 102 is configured to determine a global pose of the vehicle and comprises a GNSS receiver 102a and a visual position localisation unit 102b. The GNSS receiver 102a receives a GNSS signal providing geolocation and time information from a global navigation satellite system 100c. The localisation unit 102 further receives an inertial signal from the IMU 100b and is thus able to determine a global pose (position and direction) of the vehicle by combining the GNSS and the IMU signal. The determined pose is transmitted to the control unit 104, which controls the movement of the vehicle 50 based on the determined pose thereof.

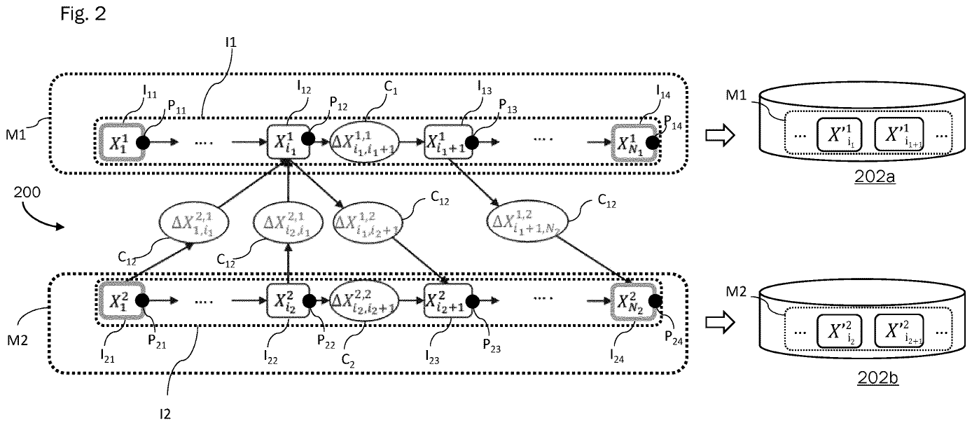

If a value of the GNSS signal is lower than a predetermined threshold, for example lower than a value at which the GNSS signal is accurate to e.g. 50 cm or 1 m, the visual position localisation unit 102b may take over the vehicle localisation. For this purpose, the visual position localisation unit 102b obtains an image from the camera 100a and sends a request for receiving one or more optimized features M1, M2 (see FIG. 2) of the vehicle's environment together with the current image to a selection unit 210 of the feature optimization device 20.

The selection unit 210 selects one or more optimized features from a plurality of sets of optimized features stored in one or more databases 202a-202c based on information provided by the current image and transmits the selected one or more optimized features back to the visual position localisation unit 102b (indicated by the double-sided arrow between the elements visual position localisation unit 102b and the selection unit 210). The latter then derives a current global pose of the vehicle 50 by performing an image registration between the current image and the received one or more optimized features. For this purpose, the received one or more optimized features may comprise the following information: 1) Global vehicle pose (map/global coordinate frame), (2) Landmarks—which include the following, e.g.: 2D features, associated 3D features, descriptors etc. (3) (optional) if an image is available that can be included. By determining the respective keypoints in the current image and performing a tracking thereof between the current image and received optimized features, the global pose of the vehicle can be derived from the global camera pose of the map.

The image processing unit 103 of the vehicle control device 20 is configured to provide image sequences based on which a map (set of optimized features) as described above can be generated.

For this purpose, the image processing unit may obtain an image sequence from the camera 100a including a predetermined number of images of the environment through which the vehicle 50 is travelling wherein one drive through may be called a run. Each image may further include motion information of the vehicle 50 obtained from the IMU 100b.

In particular, the image processing unit 102 may obtain an image sequence, when the vehicle 50 enters a region with a weak GNNS signal, in particular where the GNSS signal is below the predetermined threshold. The image sequence may include a predetermined number of captured images spaced apart from each other. The predetermined number of images in each sequence as well as the distance therebetween may be determined according to the environment being captured. For example, an image may be taken each time a significant change is detected in the vehicle's environment. It may also be possible to have equidistant intervals between the images of the image sequence.

In this context, a deterioration of the GNSS signal may be determined in advance, e.g., by estimating whether a line of sight between a GNSS satellite and the vehicle is blocked, and a first image of a respective image sequence may be captured just before the GNSS signal drops below the threshold. The last image of the image sequence may accordingly be taken when the vehicle leaves the GNSS denied region. This allows the image processing unit 102 to provide an image sequence having two reference images for feature optimization.

The image processing unit 102 may obtain an image sequence several times the vehicle passes through a same region (several runs). This allows for sensing the environment from different perspectives as the trajectories along which the vehicle has passed the region may change.

Having obtained the image sequence, the image processing unit 102 may send it to the feature optimization device 20. This means that the image processing may regularly provide an image sequence to the feature optimization device 20 for generating a set of optimized features of a region having poor GNSS availability.

The control unit 104 of the vehicle control device 10 is configured to control the movement of the vehicle 50 based on the global pose determined by the localisation unit 102. The control unit 104 may be the vehicle control unit controlling the driving operations of the vehicle 50. In the case of an autonomous driving vehicle 50, the control unit 104 may control the entire driving operation when it controls the movement of the vehicle 50, while in the case of a non-autonomous vehicle 50, the control unit 104 may control certain operations of the vehicle 50, such as parking or changing lanes when it controls the movement of the vehicle 50.

The depicted feature optimization device 20 comprises an input unit 203, a plurality of image databases 201a-201c, an optimization unit 200, a plurality of map databases 202a-202c and a selection unit 210.

The input unit 203 receives the image sequences obtained by the image processing unit 103 of the vehicle control device 10. Having received an image sequence, the input unit 203 determines one or more features from each image of the received image sequences.

The features determined by the input unit 203 may be at least one of, e.g., the images of the received image sequences, one or more reference points (keypoints) indicating distinct points, edges or objects in the images of the image sequences, an estimated camera pose of each image in the image sequences and one or more landmarks derived by transforming the reference points (keypoints) from a 2D image frame in the map frame using the estimated camera pose.

The received image sequences may be stored together with the features determined by the input device 203 in the image databases 201a-201c and may additionally be forwarded to the optimization unit 200, which optimises features, particularly the poses of the features, in the received image sequences and generates a plurality of sets of optimised features (a plurality of maps) based on the received data. In particular, the optimization unit 200 optimizes the features determined by the input unit 203 for generating the sets of optimised features. The feature, especially the pose, optimization process is described in detail below in connection with FIG. 2. The generated maps are then stored in the map databases 202a-202c from which they can be retrieved by the selection unit 210. The different map databases 202a-202c as well as the image databases 201a-201c may store, e.g., maps (sets of optimised features) and image sequences, respectively, for different regions in which the GNSS reception is limited.

The selection unit 210 retrieves at least one optimised feature, especially including the optimised pose of the optimised feature X′ᵢ^{j} from the map databases 202a-202c if it receives a respective request from the vehicle control device 10 to provide a one or more optimised features for the visual position localisation unit 102b based on which the latter can determine a current global pose of the vehicle 50. In this case, the selection unit 210 also receives a current image of the vehicle's environment from the vehicle control device 10 and selects at least one suitable/matching optimised pose (included in or being the optimised feature) from the plurality of sets of optimised features stored in the database based on the current image. This means that the feature optimization device may select the suitable optimised pose in the map to be sent to the vehicle control device according to the currently captured environment of the vehicle 50 depicted on the current image. For example, the selection unit 210 may determine one or more visual features, e.g. keypoints, from the received current image and may select a suitable optimised visual feature by comparing the determined visual features of the current image with the optimized visual features of the maps stored in the map databases 202a-202c. In this context, the selection unit may use a probabilistic model and/or an AI model to efficiently select a suitable optimised pose of map from the plurality of maps stored in the map databases 202a-202c. Having executed the selection, the selection unit 210 transmits the selected optimised pose of map to the visual position localisation unit 102b of the vehicle control device 20. The latter then derives a current global pose of the vehicle 50 by performing an image registration between the current image and the received map.

FIG. 2 shows schematically and exemplarily an optimization of two image sequences I1, I2 which may be performed by the optimization unit 200 of the system 30 shown in FIG. 1.

The two image sequences I1, I2 may be obtained by the image processing unit 102 of the control device 10 when the vehicle 50 equipped with the sensor unit 100 is travelling through a region with a weak GNNS signal, in particular a region where the GNSS signal is below the predetermined threshold. The image sequences I1, I2 were taken along two different trajectories in the same environment, e.g. by driving twice on the same road but in different lanes.

Depicted are a first image sequence I1 captured at the positions P₁₁-P₁₄ along a first trajectory on a road 60 (see FIG. 5) and a second image sequence 12 captured at the positions P₂₁-P₂₄ along a second trajectory on the same road 60. The GNSS reception along the road 60 may be such that at a first image acquisition position P₁₁, P₂₁ and a last image acquisition position P₁₄, P₂₄ the predetermined threshold value is exceeded, i.e. a reliable position determination by means of GNSS signal at these positions is possible.

Each image I₁₁-I₁₄, I₂₁-I₂₄ of the first and second image sequences I1, 12 includes one or more visual features determined by the input unit 203 as described above. In the depicted example, the optimization is carried out using the estimated camera poses of each image

$${X}_{1}^{1} - {X}_{N}^{1} , {X}_{1}^{2} - {X}_{N}^{2}$$

as optimization parameters and relative poses

$$Δ {X}_{{i}_{1 , {i}_{1 + 1}}}^{1 , 1} , Δ {X}_{{i}_{1 , {i}_{1 + 1}}}^{2 , 2}$$

between two subsequent images of each image sequence I1, I2 as first constraints C₁, C₂ and relative poses

$$Δ {X}_{1 , {i}_{1}}^{2 , 1} , Δ {X}_{{i}_{2 , {i}_{1}}}^{2 , 1} , Δ {X}_{{i}_{1 , {i}_{2 + 1}}}^{1 , 2} , Δ {X}_{{i}_{1 + 1 , {N}_{2}}}^{1 , 2}$$

between images of the first and second image sequence I1, I2 as second constraints C₁₂. All relative poses may be determined using tracking of keypoints identified in each image I₁₁-I₁₄, I₂₁-I₂₄ of the image sequences I1, I2. In terms of the first constraints C₁, C₂, it may also be possible to additionally use odometry data received form the IMU 100b of the vehicle 50 to determine the relative pose

$$Δ {X}_{{i}_{1 , {i}_{1 + 1}}}^{1 , 1} , Δ {X}_{{i}_{1 , {i}_{1 + 1}}}^{2 , 2}$$

between two successive images I₁₁-I₁₄, I₂₁-I₂₄.

As a reliable GNSS signal was available at the first and last image acquisition position P₁₁, P₂₁, P₁₄, P₂₄, the first images I₁₁, I₂₁ and the last images I₁₄, I₂₄ of the first and second image sequence I1, I2 include an absolute camera pose that may provide a third constraint for optimizing the estimated camera poses of the images in between (indicated by the bold grey frames).

In particular, the optimization unit 200 solves the following error function for generating the maps M1 and M2 from the respective image sequences I1, I2:

$$[ Mathematical Formula 1 ]$$

$$arg {min}_{{X}_{1}^{l} , {X}_{2}^{l} , … {X}_{2}^{l}} \{ {\sum }_{j = 1}^{{N}_{J}} ( {\sum }_{i = 1}^{{N}_{j - 1}} {‖ {E}_{1}^{j , i} ‖}^{2} ) + μ {\sum }_{( m , n , {i}_{m} , {i}_{n} ) ∈ T} {‖ {E}_{2}^{( m , n , {i}_{m} , {i}_{n} )} ‖}^{2} \} \qquad ( 1 )$$

$$[ Mathematical Formula 2 ]$$

$$with$$

$${E}_{1}^{j , i} = ( {X}_{i}^{j} ⊖ {X}_{i + 1}^{j} ) - Δ {X}_{i , i + 1}^{j , j} \qquad ( 2 )$$

$$[ Mathematical Formula 3 ]$$

$${E}_{2}^{m , {n}_{π} {i}_{m} , {i}_{n}} = ( {X}_{{i}_{m}}^{j} ⊖ {X}_{{i}_{n}}^{j} ) - Δ {X}_{{i}_{m} , {i}_{n}}^{m , n} \qquad ( 3 )$$

wherein the minimally parameterised motion difference operator is represented by ⊖, the estimated minimally parameterised relative pose between two consecutive images I₁₁-I₁₄, I₂₁-I₂₄ is given by equation (2) and the estimated minimally parameterised relative pose between two images of the first and second image section I1, I2 is given by equation (3). The indices i denotes a single image, the indices j denotes a trajectory and the indices m and n denote different image sequences.

This means that the sets of optimised features M1 and M2 are generated by jointly optimizing the image sequences I1, I2 considering not only the first constrains C₁, C₂ between successive images I₁₁-I₁₄, I₂₁-I₂₄ of a single image sequence I1, I2 but also second constraints C₁₂ between different images I₁₁-I₁₄, I₂₁-I₂₄ of both image sequences I1, I2. In this way, the optimization of the estimated camera pose of each image I₁₁-I₁₄, I₂₁-I₂₄ is performed over a large number of images I₁₁-I₁₄, I₂₁-I₂₄ and constraints C₁, C₂, C₁₂, thereby increasing the accuracy of the maps M1, M2 generated as a result of the optimization.

In particular, the accuracy of the sets of optimised features M1, M2 can be further increased with each further image sequence I_{new} captured on a further trajectory along the road 60. In this case, the estimated camera poses of the new image sequence I_{new} may be optimized using first constraints C_{new} between successive images thereof as well as second constraints C_{new1}, C_{new2} to images I₁₁-I₁₄, I₂₁-I₂₄ of the sets of optimised features M1, M2 already generated. In this way not only the estimated camera poses of the new image sequence I_{new} can be accurately optimized but a re-optimization of the global camera poses of each image I₁₁-I₁₄, I₂₁-I₂₄ of the sets of optimised features M1, M2 is also possible.

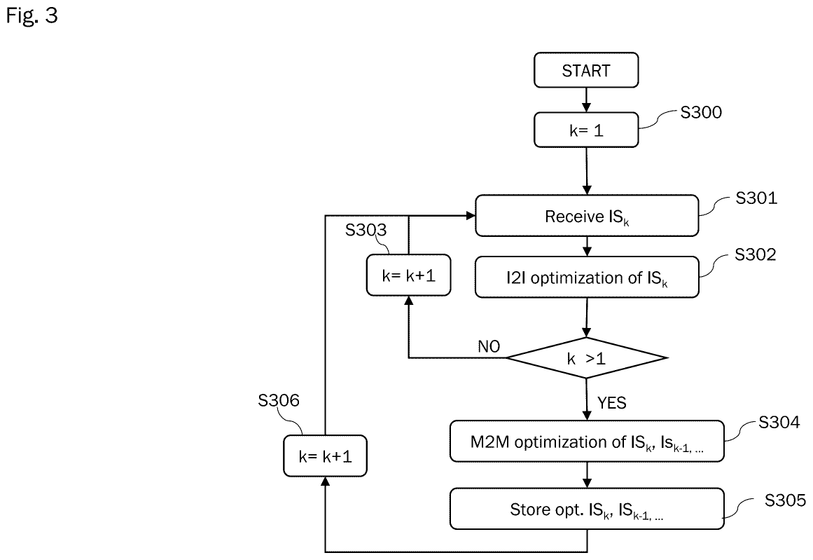

The steps for optimizing a plurality of image sequences, concretely the poses, are described in the following in connection with FIG. 3 which shows a flow chart describing exemplary steps for generating a plurality of maps using the optimization shown in FIG. 2.

The process starts at a point where the map databases 202a-202c are completely empty. This may mean, e.g., that no set of optimised features is provided for a particular region with weak GNNS reception. In a first step S300 a counter k for numbering the image sequences ISₖ is set to 1. In step S301 a first image sequence IS₁ is received by the intake unit 203 and provided to the optimization unit 200. The visual features, e.g., an estimated camera pose of each image and/or a one or more landmarks therein are then optimized in step S302 by the optimization unit 200 applying only first constraints Cₖ between successive images of the image sequence IS₁ (I2I optimization). Afterwards, it is checked whether the counter k is greater than 1 and as this is not the case for the first image sequence, the counter k is increased by 1 in step S303, and the process returns to step S301 where a second image sequence IS₂ is received.

According to the first image sequence, the visual features to be optimized of each image of the further image sequence ISₖ are optimized in step S302 considering only the first constrains Cₖ between successive images of the image sequence IS₂. However, as the counter query now leads to a positive result, a further optimization of the visual features to be optimized is carried out in step S304 considering second constraints C_{k,k-1} between images of the first and the second image sequence together with the first constrains Cₖ. In other words, the visual features of two subsequent image sequences ISₖ, ISₖ₋1 are optimized in step S304 considering not only first constrains Cₖ between successive images in one image sequence ISₖ but also second constrains C_{k,k-1} between different images of the subsequent image sequences ISₖ, ISₖ₋₁ (M2M optimizing). The images sequences ISₖ, ISₖ_i optimized in this way are then stored as sets of optimised features M_{k,1}, M_{k,2} in the databases 202a-202c (S305).

Then, the counter k is increased by one in step S306, and the process returns to step S303 where a further image sequence is received. While performing the I2I optimization in step S302 as described above, the process may perform the M2M optimization using the two sets of optimised features Mₖ₋₁ already stored in the databases 202a-202c. In particular, the visual features to be optimized of the further image sequence ISₖ may be optimized together with the visual features of both sets of optimised features M_{k-1,1}, M_{k-1,2} which have already undergone an optimizing step before. The optimized image sequence ISₖ as well as the re-optimized sets of optimised features may then be stored in the databases again in step S305. This process may be repeated until a sufficient number of maps with a sufficient accuracy are stored in the databases 202a-202c. As a result, a large number of repeatedly optimized sets of optimised features Mₖ are present in the databases 202a-202c, which can be provided to the visual position localisation unit 102b of the visual vehicle control system 10 in a situation where no sufficient GNSS signal is available

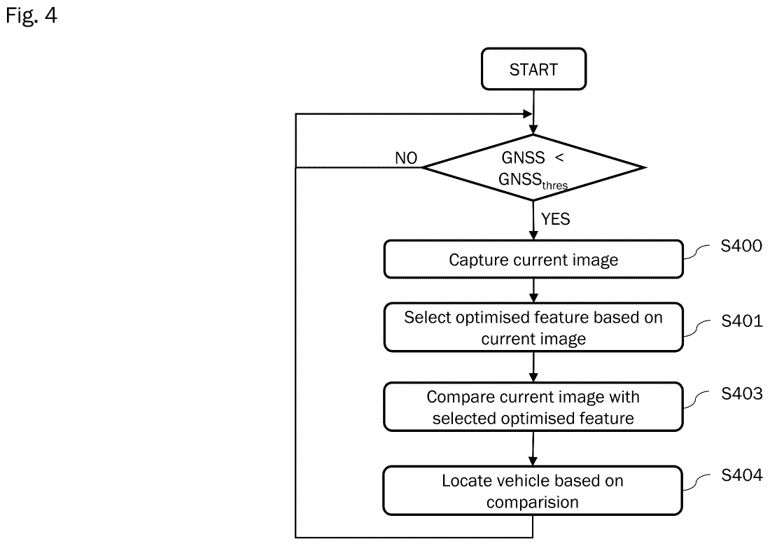

FIG. 4 shows a flow chart describing exemplary steps for determining a pose of a vehicle according to yet another embodiment of the present invention. In particular, FIG. 4 shows an example of an interaction between the visual position localisation unit 102b of the vehicle control device 10 and the selection unit 210 of the feature optimization device 20 in a situation where the vehicle 50 loses the GNSS signal.

After starting the process, it is firstly detected by the GNSS receiver 102a of the vehicle control device 10 whether the GNSS signal is below the predetermined threshold GNSSₜₕᵣₑₛ. If this is not the case, the process returns to the start and continuously monitors the GNSS signal. However, if the GNSS signal is below the threshold, the visual position localisation unit 102b causes the camera 100a to capture a current image of the environment through which the vehicle 50 is travelling (S400).

The visual position localisation unit 102b then sends the current image to the selection unit 210 of the feature optimization device, which in step S401 selects one or more suitable optimised feature (optimised pose) of a set of optimised features from a plurality of set of optimised features stored in a database 202a-202c of the feature optimization unit based on the current image received from the visual position localisation unit 102b. In this context, the selection unit 210 may determine one or more visual features from the received current image and may select an optimised feature (optimised pose) of a set of optimised features by comparing the determined visual features of the current image with the optimized visual feature of the sets of optimised features stored in the database 202a-202c. For example, the selection unit may determine one or more keypoints in the current image and may compare the determined keypoints with corresponding keypoints in the images of the sets of optimised features stored in the database 202a-202c. To perform an efficient selection, the selection unit 210 may use, for example, a probabilistic model and/or an AI model to select a map from the maps stored in the database 202a-202c. The AI model may be trained with a plurality of training sets of optimised features which may be additionally stored in the database or which may have been deleted after the training and before the deployment of the device.

Having selected an optimised feature of a set of optimised features, which is close to a visual feature in the current image, the selection unit 210 may transmit the selected optimised feature to the visual position localisation unit 102b, which in turn may compare the current image with the selected optimised visual feature of a set of optimised features (S403) and locate the global vehicle pose based on the comparison and the current image (S404). For example, the visual position localisation unit 102b may determine a relative pose of the vehicle between the current image and the optimised pose using image registration and may subsequently compute the global pose of the vehicle using the determined relative pose and the global camera pose provided by information included in the optimized features. In particular, the visual position localisation 102b unit may determine one or more keypoints in the current image and in the optimised visual feature from which the relative pose can be derived. An example of combining a determined relative pose with a global camera pose is given in FIG. 5 explained below.

After localisation of the current global pose of the vehicle, the process may return to the start and may repeat the steps S400 to S404 until a GNSS signal greater than the predetermined threshold GNSSₜₕᵣₑₛ is available.

FIG. 5 shows schematically a determination of a global pose of the vehicle 50 according to step S404 of the flow chart shown in FIG. 4.

In particular, FIG. 5 shows a plane view of the vehicle 50 travelling on the road 60 through a region of limited GNSS reception. The global coordinates (2, 2) of the vehicle 50 are shown in an x-y-coordinate system, which are firstly unknown when the vehicle 50 enters the GNSS denied region. In this case, the visual position location unit 102b of the vehicle control device 10 may take over the vehicle localisation and may send a current image of the vehicle's environment to the selection unit 210 of the feature optimization unit 20 for receiving an optimised pose providing a good match with the environment in the current image. In response to this request, the visual position location unit 102b may receive a global camera pose of map indicated by the bold cross 70 having the global coordinates c₁=(2,1) in the x-y-coordinate system.

Based on a comparison between the received global camera pose 70 of map and the current image using, e.g., image registration, the coordinates Dc₂=(0, 1) of the relative pose between the global camera pose 70 and the current global pose of the vehicle 50 can be computed. The coordinates (2, 2) of the global vehicle pose may then be determined by combining the coordinates c₁ of the global camera pose 70 with the coordinates Dc₂ of the relative pose. In this way, an efficient and accurate localisation of the vehicle's pose can be provided in GNSS denied regions, ensuring safe control of autonomous driving vehicles in all driving situations.

It is furthermore noted that examples of the present disclosure may take the form of an entirely hardware example, an entirely software example (including firmware, resident software, micro-code, etc.), or an example combining software and hardware aspects. Furthermore, examples of the present disclosure may take the form of a computer program product on a computer-readable medium having computer-executable program code embodied in the medium.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions.

Single-ended arrows generally may indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

Aspects/examples are described hereinabove with reference to flowchart illustrations and/or block diagrams of methods and apparatuses and the like. It will be understood that each block of the flowchart illustrations and/or block diagrams, and/or combinations of blocks in the flowchart illustrations and/or block diagrams can be implemented by computer-executable program code.

The computer-executable program code may be provided to a processor of a general purpose computer, special purpose computer, or other programmable data processing apparatus to produce a particular machine, such that the program code, which executes via the processor of the computer or other programmable data processing apparatus, create means for implementing the functions/acts/outputs specified in the flowchart, block diagram block or blocks, figures, and/or written description.

These computer-executable program code may also be stored in a computer-readable memory that can direct a computer or other programmable data processing apparatus to function in a particular manner, such that the program code stored in the computer readable memory produce an article of manufacture including instruction means which implement the function/act/output specified in the flowchart, block diagram block(s), figures, and/or written description.

The computer-executable program code may also be loaded onto a computer or other programmable data processing apparatus to cause a series of operational steps to be performed on the computer or other programmable apparatus to produce a computer-implemented process such that the program code which executes on the computer or other programmable apparatus provides steps for implementing the functions/acts/outputs specified in the flowchart, block diagram block(s), figures, and/or written description. Alternatively, computer program implemented steps or acts may be combined with operator or human implemented steps or acts in order to carry out an embodiment.

Communication networks generally may include public and/or private networks; may include local-area, wide-area, metropolitan-area, storage, and/or other types of networks; and may employ communication technologies including, but in no way limited to, analogue technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium.

Unless the context otherwise requires, the present disclosure should not be construed as being limited to any particular communication message type, communication message format, or communication protocol. Thus, a communication message generally may include, without limitation, an image, packet, datagram, user datagram, cell, or other type of communication message.

Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects and should not be construed to limit the disclosure to any particular logic flow or logic implementation. The described logic may be partitioned into different logic blocks (e.g., programs, modules, functions, or subroutines) without changing the overall results.

Often times, logic elements may be added, modified, omitted, performed in a different order, or implemented using different logic constructs (e.g., logic gates, looping primitives, conditional logic, and other logic constructs) without changing the overall results.

The present disclosure may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator).

Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments may also be written in conventional procedural programming languages, such as the “C” programming language or similar programming languages.

Computer program logic implementing all or part of the functionality previously described herein may be executed at different times on a single processor (e.g., concurrently) or may be executed at the same or different times on multiple processors and may run under a single operating system process/thread or under different operating system processes/threads.

Thus, the term “computer process” may refer generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies.

The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Any suitable computer readable medium may be utilized. The computer readable medium may be, for example but not limited to, an electronic, magnetic, optical, electromagnetic, infrared, or semiconductor system, apparatus, device, or medium.

More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

The programmable logic may be fixed in a signal that is transmittable to a computer using any of various communication technologies, including, but in no way limited to, analogue technologies, digital technologies, optical technologies, wireless technologies (e.g., Bluetooth), networking technologies, and internetworking technologies.

The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some aspects may be implemented as a combination of both software (e.g., a computer program product) and hardware. Still other embodiments of the may be implemented as entirely hardware, or entirely software.

While certain exemplary aspects have been described and shown in the accompanying drawings, it is to be understood that such aspects are illustrative, and that the examples are not limited to the specific constructions and arrangements shown and described, since various other changes, combinations, omissions, modifications and substitutions, in addition to those set forth in the above paragraphs, are possible.

Those skilled in the art will appreciate that various adaptations, modifications, and/or combination of the just described embodiments can be configured. Therefore, it is to be understood that, within the scope of the appended claims, the disclosure may be practiced other than as specifically described herein. For example, unless expressly stated otherwise, the steps of processes described herein may be performed in orders different from those described herein and one or more steps may be combined, split, or performed simultaneously. Those skilled in the art will also appreciate, in view of this disclosure, that different examples or aspects described herein may be combined to form other examples.

### <Second Aspect of Invention>

In the following, embodiments of the present invention are described in detail with reference to exemplary figures. The features of the embodiments may be combined in whole or in part, and the present invention is not limited to the embodiments described. In the figures, identical elements are provided with identical reference signs, so that a repeated description of the elements is omitted unless necessary.

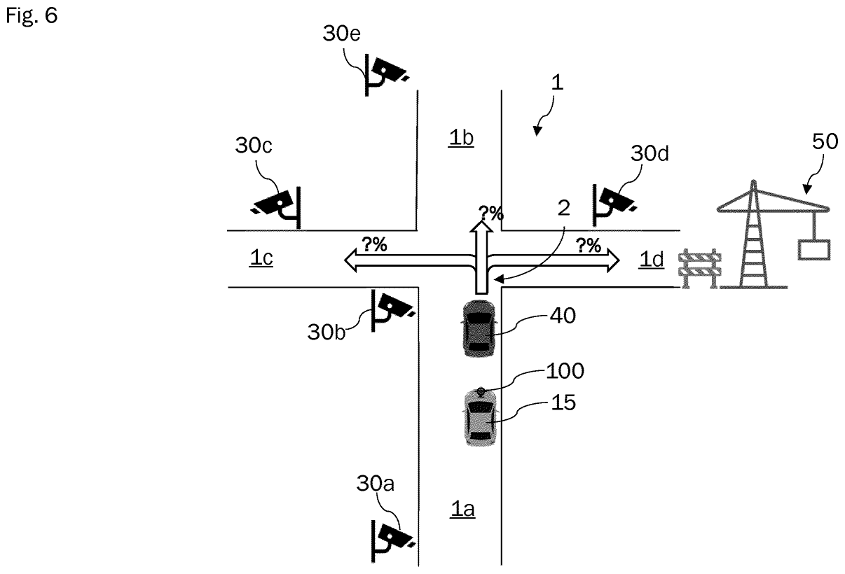

FIG. 6 shows schematically an exemplary situation at a location 2 of a predetermined road infra-structure 1 in which the present invention can be utilized. The predetermined road infrastructure 1 may comprise, for example, all or specifically selected roads 1a-1d in a city or a predetermined region. The depicted location 2 is an intersection 2 of the predetermined infrastructure 1 into which a target vehicle 40 (second vehicle) enters from a first road 1a. The intersection 2 allows to go straight into a second road 1b, to turn to the left into a third road 1c and to turn to the right into a fourth road 1d. Thus, there are three potential trajectories that the target vehicle can choose, wherein the fourth road 1d leads to a construction site 50 that cannot be traversed.

Furthermore, an ego vehicle 15 (first vehicle) is depicted in FIG. 6 that is behind the target vehicle and approaches the intersection 2 at a certain distance from the target vehicle 40. The ego vehicle 15 may be an autonomous driving vehicle, or a vehicle driven by a driver having one or more advanced driving assistance systems (ADAS), such as a braking assistant, an intersection assistant and/or a lane change assistant and may be equipped with a plurality of sensors 100, which may include at least one camera, at least one radar sensor, at least one lidar sensor, at least one ultrasonic sensor and/or at least one inertial measurement unit (IMU) (not depicted in detail). The plurality of sensors may enable the ego vehicle 15 to detect the target vehicle 40 driving in a vicinity, namely in front of the ego vehicle 15 and to estimate a state (position, heading, velocity, acceleration/deceleration etc.) and environment information of the target vehicle 40.

Two road side units 30a, 30b are arranged along the first road 1a, with a first road side unit 30a monitoring the first road 1a at a distance from the intersection 2 and a second road side unit 30b monitoring the location where the first road enters the intersection 2. A third road side unit 30c is placed next to the third road 1c and a fourth road side unit 30d is placed next to the fourth road 1d, both monitoring the respective roads 1c, 1d at a short distance from the intersection 2. Additionally, a fifth road side unit 30e is situate along the second road 1b at a distance from the intersection 2.

Each of the exemplary five road side units 30a-30e may include at least one sensor such as a camera, a radar sensor, a lidar sensor and/or an ultrasonic sensor (not depicted). The at least one sensor may allow the road side units 30a-30e to capture a trajectory, a state and information about an environment of each vehicle passing by on one of the four roads 1a-1d.

In particular, the first, second and fifth road side units 30a, 30b, 30e can be used to detect a trajectory of each vehicle approaching the intersection 2 from the road 1a and traveling straight through the intersection 2 into the road 1b. Similarly, the trajectory of a vehicle turning left at the intersection 2 into the road 1c and a vehicle turning right into the road 1d can be detected using the second and third road side units 30b, 30c and the second and fourth road side units 30b, 30d, respectively.

Information about the environment of a vehicle (environment information), may comprise information about traffic and road infrastructure in the vicinity of a vehicle on any of the four roads 1a-1d, such as traffic in lanes adjacent to the vehicle and/or traffic signs regulating the operation of the vehicle at the intersection 2 (not depicted). Such information may be detected, for example, by a camera included in each of the illustrated road side units 30a-30e (not depicted in detail) and/or by any of the sensors of the ego vehicle. Furthermore, the environment information may include map information about a location of a vehicle such as a lane map of the intersection 2 with precise positions of some important features thereof like lane marks and traffic signs in a three-dimensional view.

In the situation depicted in FIG. 6, it may be helpful for a driver and, in case of autonomous driving, for a control unit of the ego vehicle 15 to have an information about an expected trajectory of the target vehicle 40 entering the intersection 2, in order to decide as to how the ego vehicle 15 should be controlled, for example, in terms of its velocity and heading. In the illustrated example, the captured trajectory, state, and environment information of each vehicle passing the road side units 30a-30e on one of the four roads 1a-1d can be used to calculate at least one probability distribution providing, for each of the possible roads 1b-1d, a probability that a vehicle entering the intersection 2 will select that road (indicated by the question marks at the arrows indicating the three potential trajectories). The probability distribution may be calculated by a prediction device (not depicted in FIG. 6) that may be included, for example, in one of the road side units 30a-30e. It may be also possible that the prediction device is a separate sever/computer/service cloud located at an arbitrary position. Alternatively, the prediction device may be included in a vehicle control device of the ego vehicle 15. In particular, a plurality of probability distributions may be determined by the prediction device based on the captured trajectories and the corresponding states and environment information.

When detecting the target vehicle 40, a vehicle control device (not depicted in FIG. 6) of the ego vehicle may send a request for predicting an expected trajectory of the target vehicle 40 together with an estimated state thereof to the prediction device. The vehicle control device of the ego vehicle may estimate the state of the target vehicle 40 based on measuring signals of the plurality of sensors 100 attached to the ego vehicle 15 and/or based on information received from an external unit. It may also possible that the ego vehicle sends environment information of the target vehicle 40 captured by at least one of the plurality of sensors 100 to the prediction device. Alternatively or in addition at least one of the five road side units 30a-30e may send the state of the target vehicle 40 and/or environment information thereof to the prediction device.

The prediction device may calculate a probability for each of the three potential trajectories and may select the trajectory having the highest probability as the expected trajectory of the target vehicle 40. The expected trajectory as well as the probabilities for each of the three potential trajectories may be send to the vehicle control device of the ego vehicle, to enable an improved control thereof that considers the behaviour of the target vehicle 40.

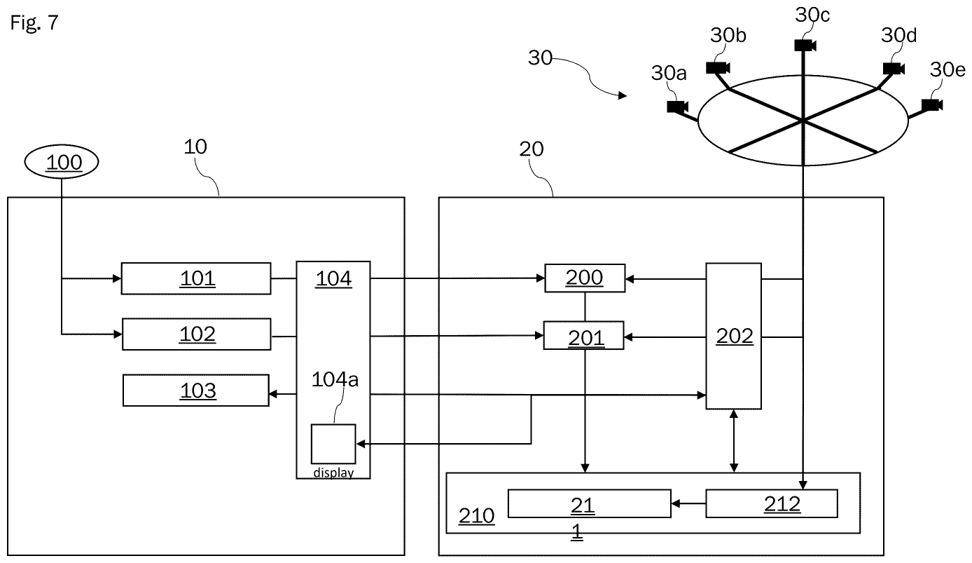

FIG. 7 shows schematically and exemplarily a system according to an embodiment of the present invention that includes a vehicle control device 10, a prediction device 20 and the five road side units 30a-30e already depicted in FIG. 6 forming a road side unit network 30.

By forming a network 30, the different road side units 30a-30e can exchange information between each other. For example the first road side unit 30a positioned alongside the first road 1a may determine a first state of the target vehicle 40 passing by and the second road side unit 1b may determine a second state of the target vehicle 40 when it enters the intersection 2 (see FIG. 6). When the second road side unit 30b detects the target vehicle 40, it may send a query to any of the other road side units 30a-30e, to check whether at least one of them has detected the target vehicle 40 before. In this manner, for example, a course of a route of the target vehicle 40 through the predetermined road infrastructure 1 can be determined by the road side unit network 30, which may be included in the state of the target vehicle 40 and updated at each road side unit 30a-30e.

The road side unit network 30 is connected to the prediction device 20 which in the example shown includes a prediction interface unit 202, a target vehicle state unit 200, an environment information unit and a model unit 210. The model unit 210 in turn comprises a prediction model 211, which in particular may be an AI model, and a training unit 212 (the training unit may not be present after the AI model has been trained before its deployment). The prediction device 20 may be a separate sever/computer/service cloud located at an arbitrary position in the predetermined road infrastructure 1 or anywhere else. In this case the prediction device 20 may be connected to the vehicle control device 10 via a network such as a wireless local area network, a cellular network and/or any other network suitable for exchanging data between the prediction device and the vehicle control unit. Alternatively the prediction device 20 may be included in the vehicle control device 10 of the ego vehicle 15.

The depicted road side units 30a-30e of the road side unit network 30 may capture a plurality of trajectories from a plurality of vehicles crossing the intersection 2 together with a state and an environment information of each vehicle and may send the trajectories captured in this way to the training unit 212 of the model unit, which may use the received trajectories for training the prediction model 211. For example, the training unit 212 may calculate a probability distribution based on the received trajectories providing, for each of the possible roads 1b-1d, a probability that a vehicle entering the intersection 2 will select that road. In particular, the training unit 212 may label each received trajectory with its state and environment information and may calculate a plurality of probability distributions for different states and environmental conditions of a target vehicle 40. In this way, the training unit 212 may provide pre-sorted training data for training the prediction model which can improve the accuracy and capabilities of the trained prediction model 211.

The vehicle control device 10 shown in FIG. 7 may be attached to the ego vehicle 15 and comprises a vehicle control unit 103, a vehicle interface unit 104 as well as a state estimation unit 101 and an environment estimation unit 102 both receiving measuring signals of the plurality of sensors 100 attached to the ego vehicle 15 (see FIG. 6) and/or from external units.

When the target vehicle 40 located in the intersection 2 is detected by at least one of the plurality of sensors 100 of the ego vehicle 15 connected to the vehicle control device 10, the state estimation unit 101 and the environment estimation unit 102 may determine/estimate a state and environment information of the target vehicle 40 using measuring signals of the plurality of sensors 100 and/or using information received from road side units 30a-30e or other sources of information. For example, the state estimation unit 101 may determine a position of the target vehicle 40 in the intersection 2 relative to the position of the ego vehicle 15 as well as its velocity and acceleration using a radar sensor, a lidar sensor and/or a camera attached to the ego vehicle 15. Alternatively or additionally, one or more of the road side units 30a-30e may submit sensor signals about the second vehicle 40 to a remote computer in which the state estimation unit 101 is located (in addition or alternatively to placing it in the control device of the ego vehicle) and which remotely determines the state of the second vehicle 40 and submits the estimated state to the ego vehicle 15.

The environment estimation unit 102 may estimate, for example, information about an infrastructure and traffic in the surroundings of the target vehicle 40 using the plurality of sensors 100. In the situation shown in FIG. 6, the environment estimation unit may, e.g., determine that the road 1d is frequently avoided by other vehicles, e.g. due to a blocking of the road or the like. It is not necessary that the environment information unit 102 indeed detects the specific cause of the behaviour of the other vehicles. Optionally, the environment information unit 102 may detect the cause, e.g., that the road leads to a construction site 50 which cannot be traversed. In this regard, the environment estimation unit may, for example, receive a signal from a camera mounted on the ego vehicle 15, which may, for example, have captured an image of a traffic sign informing about the construction site 50.

For controlling the ego vehicle 15 considering a behaviour of the target vehicle 40, the vehicle control device 10 of the ego vehicle 15 may send a request via the vehicle interface unit 104 for predicting an expected trajectory of the target vehicle 40 together with the estimated state and the environment information to the prediction device 20. The prediction device 20 may further receive a current state and current environment information of the target vehicle 40 from the road side unit network 30. The received target vehicle state information may be merged in the target vehicle state unit 200 and the received environment information may be merged in the environment information unit 201 of the prediction device 20, before both are forwarded to the model unit 210. The model unit 210 may predict the expected trajectory of the target vehicle 40 using the prediction model 211 trained with the plurality of trajectories captured by the road side units 30a-30e and/or the ego vehicle 15, considering the received state and environment information of the target vehicle 40. In particular, the prediction model 211 may calculate a probability for each of the roads 1b-1d the target vehicle 40 can select (potential trajectories) and may determine a trajectory into the road having the highest probability as expected trajectory.

The expected trajectory as well as the probabilities for each of the three potential trajectories may be send from the model unit 210 via the prediction interface unit 202 of the prediction device 20 to the vehicle interface unit 104 of the vehicle control device 10. Furthermore, the prediction device 20 may calculate driving instructions for the ego vehicle 15, such as a recommended speed and a notice to the driver, which may also be send to the vehicle interface unit 104. The vehicle interface unit 104 may show the received information on the display 104a and/or may transfer them to the vehicle control unit 103. In case that the ego vehicle 15 is an autonomous driving vehicle, the recommended speed and the notice to the driver may merely serve to inform the driver of the manner in which the ego vehicle 15 is controlled, with the driver having the option to override the automatic vehicle control. In case of non-autonomous driving, the recommended speed for the ego vehicle 15 and the notice to the driver may be a request to the driver to navigate the ego vehicle 15 depending on the predicted expected trajectory of the vehicle. In this way, the ego vehicle 15 can be controlled considering a behaviour of the target vehicle 40 in front.

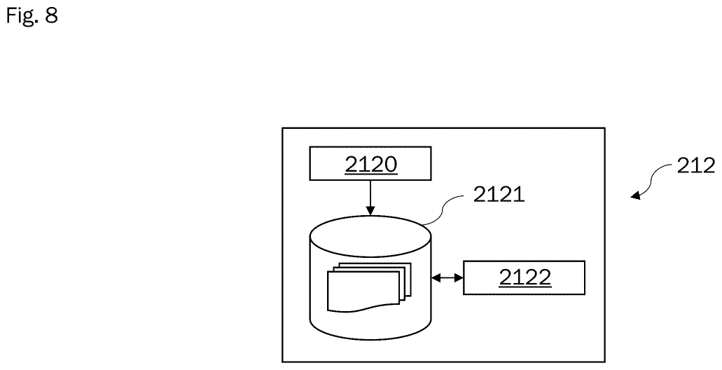

FIG. 8 shows schematically and exemplarily a training unit 212 of the prediction device depicted in FIG. 7. The training unit 212 comprises a data labelling unit 2120, a storage 2121 and a training module 2122.

As described above, the training unit 212 may receive a plurality of trajectories from a plurality of vehicles crossing the intersection 2 as well as a state and an environment information of each vehicle from the road side unit network 30. The data labelling unit 2120 may label each received trajectory with its state and environment information and may transfer the labelled trajectories to the storage 2121. The training module 2122 may cluster the labelled trajectories according to its state and environment information and may calculate a plurality of probability distributions bases on the clustered trajectories. It may also possible that the labelling unit 2120 may already cluster the labelled trajectories and calculate the corresponding probability distributions.

Each cluster may include trajectories whose state is within a predetermined range, e.g., a velocity and/or acceleration/deceleration may be between a first minimum and maximum value in a first cluster and between a second minimum and maximum value in a second cluster. Similarly, environment information of trajectories included in the same cluster may also lay in a predetermined range. For example, a number of vehicles present in an adjacent lane may be between a first minimum and maximum value in a first cluster and between a second minimum and maximum value in a second cluster.

The clusters of labelled trajectories and the plurality of probability distributions may also be stored in the storage 2121. The training module 2022 may then train/calibrate the prediction model 211 using the plurality of probability distributions of the clustered trajectories. In this way, a plurality of pre-sorted training data for training the prediction model 211 is available which can improve the accuracy and capabilities of the trained prediction model 211.

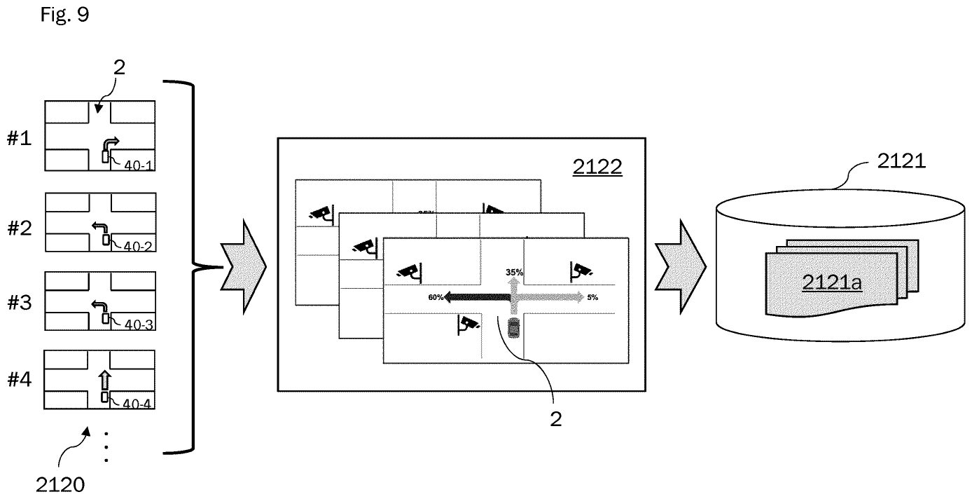

FIG. 9 shows schematically an example of as to how training data is generated by the training unit 210 depicted in FIG. 8. In particular, the example illustrates the generation of training data representing a behaviour of a plurality of vehicles crossing the intersection 2 shown in FIG. 6. For this purpose, the data labelling unit 2120 of the training unit 210 may receive a trajectory of each vehicle traversing the intersection together with a state and an environment information from the road side unit network 30. Depicted are four trajectories #1 to #4 of four vehicles 40-1 to 40-4 crossing the intersection 2, wherein the first trajectory #1 represents a turn to the right, the second and third trajectories #2, #3 represent a turn to the left and the fourth trajectory represents a straight ahead crossing of the intersection 2.

The data labelling unit 2120 may label each received trajectory #1 to #4 with a state and environment information of the corresponding vehicle 40-1 to 40-4 and may transfer the labelled trajectories #1 to #4 to the training module 2122, which may calculate a probability distribution with regard to the intersection 2 each time it receives a new labelled trajectory from the labelling unit 2120.

For example, after the model unit 210 has received the first trajectory #1 as the very first trajectory, it may calculate the probability distribution to be 100%, turn right, 0% turn left, 0% go straight. When receiving the subsequent trajectories #2 to #4, the model unit 210 may adjust the probability distribution as follows:
#2: 50% turn right, 50% turn left, 0% go straight;
#3: 33.3% turn right, 66.6% turn left, 0% go straight; and
#4: 25% turn right, 50% turn left, 25% go straight.

In this context, the data labelling unit 2120 or the training module 2122 may cluster the labelled trajectories depending on their state and environment information, and the training module 2122 may calculate a probability distribution as described above for each cluster of trajectories as training data 2121a which is then stored in the storage 2121.

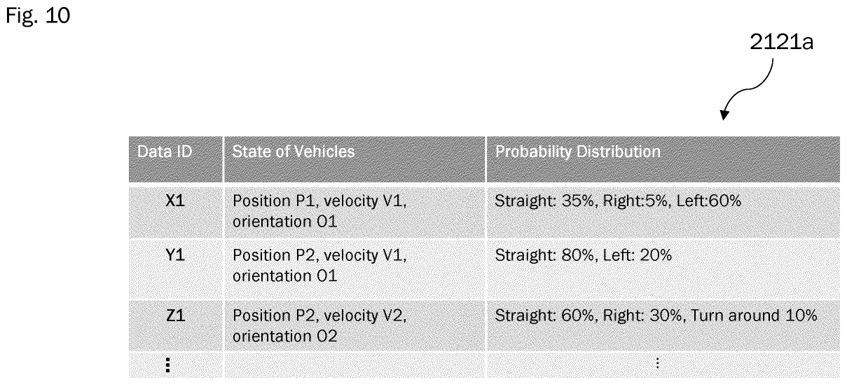

FIG. 10 shows schematically and exemplarily a result of the training data generation for the intersection 2 depicted in FIG. 9. In particular, the depicted training data 2121a include a list with three columns, wherein the first column includes a data ID identifying the different clusters of trajectories, the second column includes the state of the vehicles assigned to a respective cluster, and the third column includes the probability distribution of the trajectories assigned to the respective cluster. The state preferably includes the parameters location, velocity and orientation (heading) of the vehicles delivering the trajectories for each cluster X1 to Z1. A cluster can include states that are within a predetermined range. In other words, each cluster can contain a minimum and a maximum value for a position, a velocity, and an orientation. For example, a position of P=10, a velocity of V=25, and an orientation of O=0 may belong to the same cluster X1 as a position of P=10.5, a velocity of V=25, and an orientation O=0.2.

According to the training data 2121a as shown, a vehicle situated at a position P1 in the intersection 2 and having a velocity V1 and an orientation O1 (data ID X1) has a probability to go straight ahead of 35%, to turn to the right of 5% and to turn to the left of 60%. Thus, if the vehicle control device 10 of the ego vehicle 15 estimates the vehicle state X1 for the target vehicle 40 in front and sends it to the prediction device 20 together with a request for predicting an expected trajectory of the target vehicle 40, the model unit 210 of the prediction device 20 may predict a turn to the left as an expected trajectory thereof. In case the target vehicle 40 is situated with the same velocity and orientation V1, O1 at a position P2 in the intersection (data ID Y1), the prediction unit 210 may predict that the target vehicle goes straight ahead, as the probability therefore is 80%. The position P2 may be, for example, a position in a middle lane of a plurality of lanes at the intersection 2. If the state of the target vehicle 40 corresponds to that of the cluster with data ID Z1, the model unit 210 of the predictive model 20 may predict a 60% probability that the target vehicle 40 will go straight, 30% that it will turn right, and 10% that it will perform a U-turn.

By performing a training of the prediction model 211 in the training module 2122 using training data 2121a as shown in FIG. 10, which includes probability distributions for potential trajectories at the intersection 2 associated with a plurality of possible states of the target vehicle 40, a reliable prediction of the expected trajectory can be provided by the prediction device 20.

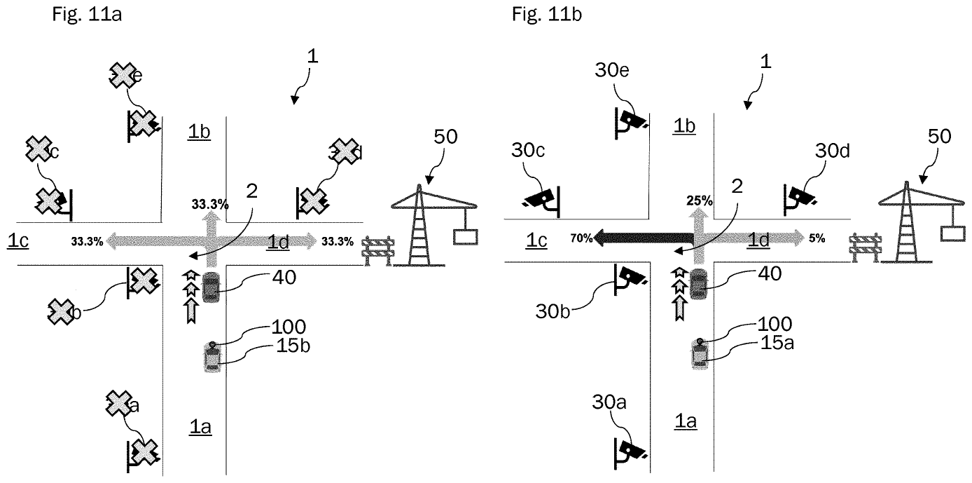

FIGS. 11a and 11b show schematically another exemplary situation at the intersection 2 of the predetermined road infrastructure shown in FIG. 6 in which the present invention can be utilized.

The intersection 2 allows to go straight into a second road 1b, to turn to the left into a third road 1c and to turn to the right into a fourth road 1d. Thus, there are three potential trajectories that the target vehicle 40 can choose, wherein the fourth road 1d leads to a construction site 50 that cannot be traversed. In the situation depicted in FIGS. 11a and 11b the target vehicle 40 enters the intersection and decelerates (indicated by the arrows decreasing in length next to the target vehicle 40).

The ego-vehicle 15b shown in FIG. 11a may include a control device that only assesses the state of the target vehicle 40 ahead to estimate whether or not it will turn left and to control a possible overtake operation of the ego-vehicle 15b. This means that the control device does not receive information from the road side units 30a-30e about an expected trajectory of the target vehicle (indicated by the crosses above the road side units and their reference signs). As a result, the control device of the ego vehicle 15b must estimate an equal probability of 33.3% for each possible trajectory of the target vehicle 40 ahead.

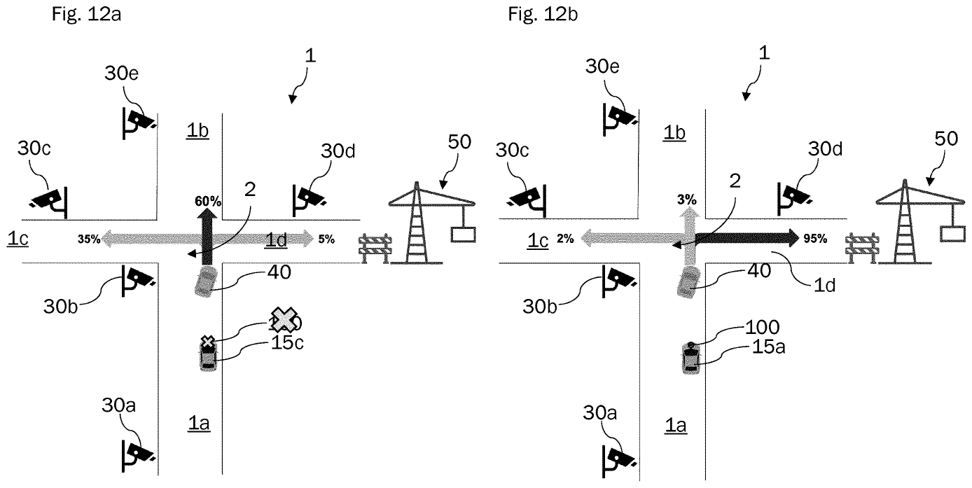

To the contrary, the ego vehicle 15a depicted in FIG. 11b may include a vehicle control unit 10 as shown in FIG. 7, which sends a request to a prediction device 20 for receiving an estimated trajectory of the target vehicle 40 based on a current state and environment information of the target vehicle 40 estimated by the ego vehicle 15a and/or the road-side units 30a-30e. As described above, the prediction device 20 may include a model unit 210 including a prediction model 211 trained with a plurality of trajectories acquired from vehicles crossing the intersection 2 and having different states and environmental conditions. Thus, the prediction model 211 considers the behaviour of a plurality of vehicles having crossed the intersection while the construction side 50 blocks the passage of the fourth road 1d. As a result, the prediction device 20 calculates a probability of only 5% that the target vehicle 40 will turn to the right in the fourth road 1d leading to the construction side 50. Furthermore, the prediction device 20 calculates a probability of 70% that the target vehicle 40 will turn to the left and a probability of 25% that the target vehicle 40 will go straight ahead. The prediction device 20 may send the probability distribution to the vehicle control device 10 Of the ego vehicle 15, which may then control the ego vehicle 15 so that it does not overtake the target vehicle 40 on the left. It becomes clear from the comparison of FIGS.-11a and 11b that a combination of estimating a state and environment information of the target vehicle 40 and considering statistical information regarding the behaviour of vehicles at the intersection 2 allows for providing a reliable prediction of the target vehicle's expected trajectory. 10201.1 FIGS. 12a and 12b show schematically yet another exemplary situation at the intersection 2 of the predetermined road infrastructure 1 shown in FIG. 6 in which the present invention can be utilized. The potential trajectories that the target vehicle 40 may choose are the same as in the FIGS. 6, 11a and 11b. In the situation depicted in FIGS. 12a and 12b the target vehicle 40 enters the intersection at a reduced velocity and positions itself therein with its front facing to the right.

The ego-vehicle 15c shown in FIG. 12a may include a control device that only uses statistical information regarding the behaviour of vehicles at the intersection 2 to estimate whether or not it will turn left and does not consider the current state of the target vehicle 40 in front to control a possible overtake operation of the ego-vehicle 15b. This means that the control device of the ego vehicle 15c does not have information about the position and the velocity of the target vehicle 40. In other words, in the situation shown the ego vehicle cannot recognize that the target vehicle 40 has positioned such that its front is facing to the right. Therefore, the control device of the ego vehicle 15c estimates only a 5% probability that the target vehicle 40 will turn right, since only a few vehicles, in particular only construction vehicles, have entered the fourth road 1d in the past due to the construction site 50. Furthermore, the control device of the ego vehicle 15c, having only statistical information about the traffic on the intersection 2, estimates a 60% probability that the target vehicle 40 will go straight and a 35% probability that the target vehicle 40 will turn left.

To the contrary, the ego vehicle 15a depicted in FIG. 12b may include a vehicle control unit 10 as shown in FIG. 7 estimating the current state and environmental conditions of the target vehicle which are then considered by the prediction device when calculating the probability distribution using a trained prediction model. Alternatively or additionally, one or more of the road side units 30a-30e may submit sensor signals about the second vehicle 40 to a remote computer in which the state estimation unit 101 is located (in addition or alternatively to placing it in the control device of the ego vehicle) and which remotely determines the state of the second vehicle 40 and submits the estimated state to the ego vehicle 15a. In the situation shown in FIGS. 12a and 7b, this means that the prediction device 20 is aware that the target vehicle 40 has already turned its front to the right, even though the road 1d on the right side of the intersection 2 supplies to the construction site 50. As a result, the prediction device 20 calculates a 95% probability that the target vehicle 40 will turn right onto the fourth road 1d to the construction site 50 and only 3% and 2%, respectively, that it will choose a different direction. By comparing the predicted probability distributions shown in the FIGS. 12a and 12b, it becomes obvious that monitoring a current state of a target vehicle 40 is essential for a reliable prediction of its expected trajectory. In particular, a combination of estimating the state and the environmental conditions of the target vehicle and considering statistical information regarding the behaviour of vehicles at the intersection 2 allows for further improving the accuracy of the prediction.

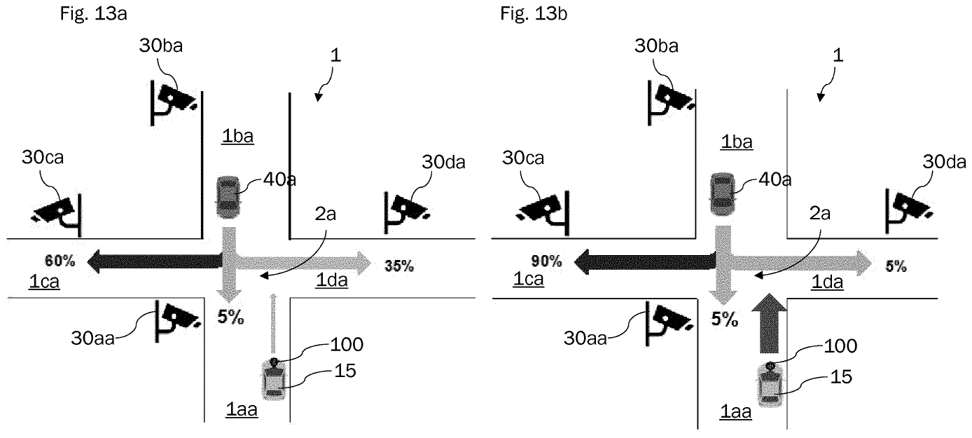

FIGS. 13a and 13b show schematically one more exemplary situation at another intersection 2a of the predetermined road infrastructure 1 in which the present invention can be utilized. In particular, FIGS. 13a and 13b show as to how the vehicle control device 10 shown in FIG. 7 controls the ego vehicle 15 in response to a probability distribution of potential trajectories of an oncoming target vehicle 40a, the probability distribution calculated by the prediction device 20 shown in FIG. 7.

As with intersection 2, four roads 1aa, 1ba, 1ca, 1da cross at intersection 2a, and four road side units 30ba, 30ca, 30da, and 30ea are placed at the edge of each of the roads 1aa, 1ba, 1ca, 1da. One road side unit 30aa is located along a first road 1aa monitoring the location where the first road 1aa enters the intersection 2a. A second road side unit 30ba is placed along a second road 1ba leading straight ahead out of the intersection 2a and two more road side units 30ca, 30da are situated at a third and fourth road 1ca, 1da leading on the left and right, respectively, out of the intersection 2a. The latter monitor vehicles driving along the respective roads 1ba, 1ca, 1da when leaving the intersection. By combining the information of the four road side units, trajectories of a plurality of vehicles crossing the intersection 2a can be acquired. In contrast to the intersection 2, all four roads 1aa to 1da can be traversed, as no construction site blocks any of them.

In the situation shown in FIGS. 13a and 13b, the vehicle control device 10 of the ego vehicle 15 controls the latter to go straight through the intersection and requests a prediction of an expected trajectory of the oncoming target vehicle 40a from the prediction device, for determining an appropriate velocity for passing the intersection 2a.

According to the probability distribution shown in FIG. 13a (probabilities added to the arrows indicating the potential trajectories of the target vehicle 40a), the prediction device 20 calculates a 60% probability that the target vehicle 40a will turn into the third road 1c, a 5% probability that it will go straight ahead and a 35% probability that it will turn into the fourth road 1da crossing the path of the ego vehicle 15. Due to the relatively high probability that the target vehicle 40a will cross the ego vehicle's path, the vehicle control device 10 may controls the ego vehicle 15 to enter the intersection at a low speed (e.g., lower or equal to 15 km/h), indicated by the thin arrow in front of the ego vehicle 15. The recommended vehicle speed together with a notice to a driver to be aware of a potentially crossing vehicle may be shown on the display 104a of the vehicle control device 10.

In contrast, the probability distribution shown in FIG. 13b, calculated by the prediction device 20, shows a 90% probability that the target vehicle 40 a will turn into the third road 1c, a 5% probability that it will go straight ahead and only a 5% probability that it will turn into the fourth road 1da crossing the path of the ego vehicle 15. Due to the relatively low probability that the target vehicle 40a will cross the ego vehicle's path, the vehicle control device 10 controls the ego vehicle 15 to enter the intersection at a higher speed (e.g. higher than 15 km/h up to 40 km/h), indicated by the bold arrow in front of the ego vehicle 15. Again, the recommended vehicle speed together with a corresponding notice to the driver may be shown on the display 104a of the vehicle control device 10. It becomes clear from the two control examples shown in the FIGS. 13a and 13b, that a reliable prediction of a target vehicle's expected trajectory, as provided by the embodiments of the present invention shown above, allows for improving the control of an ego vehicle such that its behaviour can be adapted to a behaviour of the target vehicle.

Summarizing, a vehicle control device, a prediction device, a system, a method and a computer program product for controlling a first vehicle (ego vehicle) when a second vehicle (target vehicle) is detected in its vicinity can be provided which in particular increase the safety of occupants of the first vehicle by taking into account an expected behaviour of the second vehicle when controlling the first vehicle. The expected behaviour of the second vehicle is predicted based on information about a behaviour of a plurality of vehicles monitored at a location of the second vehicle taking into account a state of each of the plurality of monitored vehicles, which may be, e.g., position, heading, velocity and/or acceleration/deceleration of the respective vehicle.

It is furthermore noted that examples of the present disclosure may take the form of an entirely hardware example, an entirely software example (including firmware, resident software, micro-code, etc.), or an example combining software and hardware aspects. Furthermore, examples of the present disclosure may take the form of a computer program product on a computer-readable medium having computer-executable program code embodied in the medium.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions.

Single-ended arrows generally may indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

Aspects/examples are described hereinabove with reference to flowchart illustrations and/or block diagrams of methods and apparatuses and the like. It will be understood that each block of the flowchart illustrations and/or block diagrams, and/or combinations of blocks in the flowchart illustrations and/or block diagrams can be implemented by computer-executable program code.

The computer-executable program code may be provided to a processor of a general purpose computer, special purpose computer, or other programmable data processing apparatus to produce a particular machine, such that the program code, which executes via the processor of the computer or other programmable data processing apparatus, create means for implementing the functions/acts/outputs specified in the flowchart, block diagram block or blocks, figures, and/or written description.

These computer-executable program code may also be stored in a computer-readable memory that can direct a computer or other programmable data processing apparatus to function in a particular manner, such that the program code stored in the computer readable memory produce an article of manufacture including instruction means which implement the function/act/output specified in the flowchart, block diagram block(s), figures, and/or written description.

The computer-executable program code may also be loaded onto a computer or other programmable data processing apparatus to cause a series of operational steps to be performed on the computer or other programmable apparatus to produce a computer-implemented process such that the program code which executes on the computer or other programmable apparatus provides steps for implementing the functions/acts/outputs specified in the flowchart, block diagram block(s), figures, and/or written description. Alternatively, computer program implemented steps or acts may be combined with operator or human implemented steps or acts in order to carry out an embodiment.

Communication networks generally may include public and/or private networks; may include local-area, wide-area, metropolitan-area, storage, and/or other types of networks; and may employ communication technologies including, but in no way limited to, analogue technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium.

Unless the context otherwise requires, the present disclosure should not be construed as being limited to any particular communication message type, communication message format, or communication protocol. Thus, a communication message generally may include, without limitation, a frame, packet, datagram, user datagram, cell, or other type of communication message.

Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects and should not be construed to limit the disclosure to any particular logic flow or logic implementation. The described logic may be partitioned into different logic blocks (e.g., programs, modules, functions, or subroutines) without changing the overall results.

Often times, logic elements may be added, modified, omitted, performed in a different order, or implemented using different logic constructs (e.g., logic gates, looping primitives, conditional logic, and other logic constructs) without changing the overall results.

The present disclosure may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator).

Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code maybe converted (e.g., via a translator, assembler, or compiler) into a computer executable form.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments may also be written in conventional procedural programming languages, such as the “C” programming language or similar programming languages.

Computer program logic implementing all or part of the functionality previously described herein may be executed at different times on a single processor (e.g., concurrently) or may be executed at the same or different times on multiple processors and may run under a single operating system process/thread or under different operating system processes/threads.

Thus, the term “computer process” may refer generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies.

The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Any suitable computer readable medium may be utilized. The computer readable medium may be, for example but not limited to, an electronic, magnetic, optical, electromagnetic, infrared, or semiconductor system, apparatus, device, or medium.

More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

The programmable logic may be fixed in a signal that is transmittable to a computer using any of various communication technologies, including, but in no way limited to, analogue technologies, digital technologies, optical technologies, wireless technologies (e.g., Bluetooth), networking technologies, and internetworking technologies.

The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some aspects may be implemented as a combination of both software (e.g., a computer program product) and hardware. Still other embodiments of the may be implemented as entirely hardware, or entirely software.

While certain exemplary aspects have been described and shown in the accompanying drawings, it is to be understood that such aspects are illustrative, and that the examples are not limited to the specific constructions and arrangements shown and described, since various other changes, combinations, omissions, modifications and substitutions, in addition to those set forth in the above paragraphs, are possible.

Those skilled in the art will appreciate that various adaptations, modifications, and/or combination of the just described embodiments can be configured. Therefore, it is to be understood that, within the scope of the appended claims, the disclosure may be practiced other than as specifically described herein. For example, unless expressly stated otherwise, the steps of processes described herein may be performed in orders different from those described herein and one or more steps may be combined, split, or performed simultaneously. Those skilled in the art will also appreciate, in view of this disclosure, that different examples or aspects described herein may be combined to form other examples.

### REFERENCE SIGNS LIST

10 vehicle control device
20 feature optimization device
30 system
50 vehicle
100 sensor unit
100c global navigation satellite system
102 localisation unit
102a GNSS receiver
102b visual position localisation unit
103 image processing unit
104 control unit
200 optimization unit
202a to 202c map database
203 input unit
210 selection unit
1 road infrastructure
2, 2a location
15 first vehicle
20 prediction device
30a-30e road side unit
40 second vehicle
100 sensor
101 state estimation unit
102 environment estimation unit
103 vehicle control unit
104 vehicle interface unit
104a display
202 prediction interface unit
210 model unit
211 prediction model
212 training unit

1. A vehicle control device for controlling a movement of a vehicle being equipped with one or more sensors comprising:
a localisation unit configured to determine a global pose of the vehicle; and
a control unit configured to control the movement of the vehicle based on the determined global pose, wherein
the localisation unit includes a visual position localisation unit configured to obtain a current image of an environment of the vehicle from the one or more sensors,
to send the current image to a feature optimisation device storing one or more sets of optimised features of the environment of the vehicle in a database,
to receive, from the optimisation device, at least one optimised feature from the sets of optimised features based on the current image, and
to determine the global pose of the vehicle based on a comparison of the current image and the at least one received optimised feature (M1).

2. The vehicle control device according to claim 1, wherein
the at least one optimised feature received by the localisation unit is selected from a plurality of sets of optimised features, each of which is corresponding to one of a plurality of runs, stored in one or more databases based on the current image.

3. The vehicle control device according to claim 1, wherein
the visual position localisation unit is configured to perform the comparison by determining one or more features in the current image and the at least one optimised feature received from the optimisation device and computing a relative pose between corresponding features, and
to determine the global pose of the vehicle by combining the computed relative pose with a global camera pose derived from the optimised feature (M1, M2).

4. The vehicle control device according to claim 1, wherein
the localisation unit further includes a GNSS receiver configured to receive a signal from a global satellite navigation system, and
if a signal strength of a received GNSS signal is equal to or greater than a predetermined threshold,
the localisation unit is configured to determine the global pose of the vehicle based on the GNSS signal, and
if the signal strength of the GNSS signal is lower than the predetermined threshold,
the visual position localisation unit is configured to determine the global pose of the vehicle.

5. The vehicle control device according to claim 4, further comprising:
an image processing unit configured to obtain an image sequence (I1, I2) from the one or more sensors including a predetermined number of images (I₁₁-I₁₄, I₂₁-I₂₄) of the environment of the vehicle when the vehicle passes through a region where the received GNSS signal is lower than the predetermined threshold, wherein at least a first image (I₁₁, I₂₁) and a last image (I₁₄, I₂₄) of the image sequence (I1, I2) include a global pose of the vehicle determined based on the GNSS signal, and
to send the obtained image sequence (I1, I2) to the feature optimisation device.

6. A feature optimisation device providing at least one optimised feature for controlling a movement of a vehicle being equipped with one or more sensors, the feature optimisation device comprising:
an input unit configured to receive at least two image sequences (I1, I2) of an environment of the vehicle from a vehicle control device, the image sequences (I1, I2) obtained along different trajectories in the same environment, and to determine one or more features from each image (I₁₁-I₁₄, I₂₁-I₂₄) of the received image sequences (I1, I2);
an optimization unit configured to compute, based on the determined one or more features, a first constraint (C₁, C₂) between two successive images (I₁₁-I₁₄, I₂₁-I₂₄) of the at least two image sequences (I1, I2) and a second constraint (C12) between an image (I₁₁-I₁₄) of a first image sequence (I1) and an image (I₂₁-I₂₄) of a second image sequence (I2),
to optimize at least one of the determined features of each image (I₁₁-I₁₄, I₂₁-I₂₄) of the at least two image sequences (I1, I2) based on the first and second constraints (C₁, C₂, C₁₂), and to store each of the image sequences (I1, I2) and/or the optimised features in at least two sets of optimised features (M1, M2) in one or more databases;
a selection unit configured to receive a current image of the vehicle's environment from the vehicle control device, to select at least one optimised feature from the at least two sets of optimised features (M1, M2) stored in the database based on the current image, and to transmit the selected at least one optimised feature to the vehicle control device.

7. The feature optimization device according to claim 6, wherein
the selection unit is configured to determine one or more features from the received current image, and to select one or more optimised features by comparing the determined features of the current image with the optimized features of the sets of optimised features (M1, M2) stored in the database.

8. The feature optimization device according to claim 6, wherein
the selection unit is configured to use a probabilistic model and/or an AI model to select optimised features from the sets of optimised features (M1, M2) stored in the database.

9. The feature optimization device according to claim 6, wherein
the input unit is configured to determine one or more reference points in each image (I₁₁-I₁₄, I₂₁-I₂₄) of the at least two image sequences (I1, I2) as the one or more features, and
the optimization unit is configured to compute the first constraint (C₁, C₂) by determining a first relative pose between two corresponding reference points in the successive images (I₁₁-I₁₄, I₂₁-I₂₄) of the at least two image sequences (I1, I2), and to compute the second constraint (C₁₂) by determining a second relative pose between two corresponding reference points in the image of the first image sequence (I₁₁-I₁₄) and the image of the second image sequence (I₂₁-I₂₄).

10. The feature optimization device according to claim 6, wherein
the input unit is configured to determine an estimated camera pose of each image (I₁₁-I₁₄, I₂₁-I₂₄) of the at least two image sequences (I1, I2) for the at least one feature to be optimized, and
the optimization unit is configured to optimize the estimated camera pose based on the first and second constraints (C₁, C₂, C₁₂), to generate a global camera pose for each image (I₁₁-I₁₄, I₂₁-I₂₄) of the sets of optimised features (M1, M2).

11. The feature optimization device according to claim 9, wherein
the input unit is configured to determine a global pose of the vehicle in a first and a last image (I₁₁, I₂₁, I₁₄, I₂₄) of the at least two image sequences (I1, I2) based on a GNSS signal received by the one or more sensors, and
the optimization unit is configured to optimize the estimated camera pose of each image (I₁₁-I₁₄, I₂₁-I₂₄) of the at least two image sequences (I1, I2) based on the first and second constraints (C₁, C₂, C₁₂) and the global camera pose in the first and last image (I₁₁, I₂₁, I₁₄, I₂₄).

12. The feature optimization device according to claim 6, wherein
if the input unit receives a new image sequence from the vehicle control device,
the input unit is configured to determine one or more features from each image of the received new image sequence; and
the optimization unit is configured to compute, based on the determined features, a first constraint between two successive images of the new image sequence and a second constraint between an image of the new image sequence and an image of the at least two maps already stored in the database,
to optimize at least one of the determined features of each image of the new image sequence based on the first and second constraints, and to store the new image sequence with the set of optimized features in the database.

13. The feature optimization device according to claim 12, wherein
the optimization unit is configured to further optimise the at least one of the features of the at least two sets of optimised features (M1, M2) already stored in the database based on the second constraint between the image of the new image sequence and the image of the at least two sets of optimised features (M1, M2).

14. A system for controlling a movement of a vehicle, comprising:
a vehicle control device for controlling a movement of a vehicle being equipped with one or more sensors comprising:
a localisation unit configured to determine a global pose of the vehicle; and
a control unit configured to control the movement of the vehicle based on the determined global pose, wherein
the localisation unit includes a visual position localisation unit configured to obtain a current image of an environment of the vehicle from the one or more sensors,
to send the current image to a feature optimisation device storing one or more sets of optimised features of the environment of the vehicle in a database,
to receive, from the optimisation device, at least one optimised feature from the sets of optimised features based on the current image, and
to determine the global pose of the vehicle based on a comparison of the current image and the at least one received optimised feature (M1);
a feature optimization device according to claim 6; and
one or more sensors attached to the vehicle and configured to transmit a plurality of sensor signals to the control device and/or the feature optimization device.

15. A vehicle comprising:
a vehicle control device according to claim 1, and
one or more sensors attached to the vehicle and configured to transmit a plurality of sensor signals to the control device and/or the feature optimization device.

16. The vehicle according to claim 15, further comprising:
a feature optimization device providing at least one optimised feature for controlling a movement of a vehicle being equipped with one or more sensors, the feature optimisation device comprising:
an input unit configured to receive at least two image sequences (I1, I2) of an environment of the vehicle from a vehicle control device, the image sequences (I1, I2) obtained along different trajectories in the same environment, and to determine one or more features from each image (I₁₁-I₁₄, I₂₁-I₂₄) of the received image sequences (I1, I2);
an optimization unit configured to compute, based on the determined one or more features, a first constraint (C₁, C₂) between two successive images (I₁₁-I₁₄, I₂₁-I₂₄) of the at least two image sequences (I1, I2) and a second constraint (C12) between an image (I₁₁-I₁₄) of a first image sequence (I1) and an image (I₂₁-I₂₄) of a second image sequence (I2),
to optimize at least one of the determined features of each image (I₁₁-I₁₄, I₂₁-I₂₄) of the at least two image sequences (I1, I2) based on the first and second constraints (C₁, C₂, C₁₂), and to store each of the image sequences (I1, I2) and/or the optimised features in at least two sets of optimised features (M1, M2) in one or more databases;
a selection unit configured to receive a current image of the vehicle's environment from the vehicle control device, to select at least one optimised feature from the at least two sets of optimised features (M1, M2) stored in the database based on the current image, and to transmit the selected at least one optimised feature to the vehicle control device.

17. A method for controlling a movement of a vehicle equipped with one or more sensors, comprising the steps:
receiving at least two image sequences (I1, I2) of an environment of the vehicle from a vehicle control device, the image sequences obtained along different trajectories in the same environment, and determining one or more features from each image (I₁₁-I₁₄, I₂₁-I₂₄) of the received image sequences (I1, I2);
computing, based on the determined features, a first constraint (C₁, C₂) between two successive images (I₁₁-I₁₄, I₂₁-I₂₄) of the at least two image sequences (I1, I2) and a second constraint (C12) between an image (I₁₁-I₁₄) of a first image sequence (I1) and an image (I₂₁-I₂₄) of a second image sequence (I2);
optimizing at least one feature of each image (I₁₁-I₁₄, I₂₁-I₂₄) of the at least two image sequences (I1, I2), based on the first and second constraints (C1, C2, C12), to generate a global camera pose for each image (I₁₁-I₁₄, I₂₁-I₂₄), and storing each of the image sequences (I1, I2) in a database,
receiving a current image of the vehicle's environment from the vehicle control device;
selecting at least one optimised features from at least two sets of optimised features (M1, M2) stored in the database based on the current image;
determining the global pose of the vehicle based on a comparison of the feature in the current image and the selected optimised feature of the set of optimised features (M1, M2); and
controlling the movement of the vehicle based on the determined global pose.

18. A computer program product storable in a memory comprising instructions which, when carried out by a computer, cause the computer to perform the method according to claim 17.
